(19) United States
(12) Patent Application Publication
(10) Pub. No.: US 2026/0029742 A1
(43) Pub. Date: Jan. 29, 2026

(54) METHOD FOR CLEANING ADHESIVE TONER ADHERED TO BOOKLET MAKING APPARATUS

(71) Applicant: CANON KABUSHIKI KAISHA, Tokyo (JP)

(72) Inventors: Masatake USUI, Shizuoka (JP); Kenji TAKAGI, Kanagawa (JP)

(21) Appl. No.: 19/279,362

(22) Filed: Jul. 24, 2025

(30) Foreign Application Priority Data
Jul. 25, 2024 (JP) 2024-120334

(51) Int. Cl. G03G 15/00; B08B 1/10; B42C 3/00; G03G 21/00

(52) U.S. Cl. CPC G03G 15/6544; B08B 1/10; B42C 3/00; G03G 15/6585; G03G 21/00; G03G 2215/00835; G03G 2215/00936; G03G 2221/0005

(57) ABSTRACT

Provided is a heater that performs heat processing when a sheet bundle is stacked on a holding plate. A storage elastic modulus of a toner image by an adhesive toner formed on a sheet of interest closest to the heater in an N−1-th sheet bundle second closest to the heater in a booklet is greater than a storage elastic modulus of a toner image by the adhesive toner formed on any sheet included in another sheet bundle located farther from the heater than the N−1-th sheet bundle in the booklet.

### BACKGROUND

### Field of the Technology

The present disclosure relates to a method for cleaning adhesive toner adhered to a booklet making apparatus.

### Description of the Related Art

The booklet making apparatus makes a booklet by stapling a plurality of sheets on which an image is printed by an electric stapler. However, metal staples prevent the booklet from being recycled. Japanese Patent Laid-Open No. 2014-237291 discusses a post-processing apparatus that forms an adhesive toner image on a sheet together with an image prepared by a user, and stacks, heats and pressurizes the plurality of sheets to make a booklet.

In some cases, the adhesive toner is adhered to a thermocompression adhesion portion of the post-processing apparatus. In this case, the adhesive toner may be transferred from the thermocompression adhesion portion to a cover (front cover or back cover) of the booklet, and the cover may be contaminated by the adhesive toner.

### SUMMARY

The present disclosure provides a booklet making apparatus that includes a holding plate configured to hold a sheet bundle composed of two or more sheets, each of which is formed with a toner image by an adhesive toner in an adhesive region; a pressurizing plate configured to apply pressure to the sheet bundle held by the holding plate; a heater configured to apply heat to the toner image formed by the adhesive toner in the adhesive region of each sheet contained in the sheet bundle held by the holding plate; and a discharging unit configured to discharge a booklet upon completion of the booklet composed of N sheet bundles. The heater performs heat processing in response to the sheet bundle being stacked on the holding plate, and a storage elastic modulus of the toner image formed by the adhesive toner on a sheet of interest closest to the heater in an N−1-th sheet bundle second closest to the heater in the booklet is greater than a storage elastic modulus of the toner image formed by the adhesive toner on any sheet included in another sheet bundle located farther from the heater than the N−1-th sheet bundle in the booklet.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an image forming system.

FIGS. 2A, 2B and 2C are diagrams illustrating adhesive regions provided on a sheet.

FIGS. 3A to 3D are diagrams illustrating an intermediate stacking unit.

FIGS. 4A to 4C are diagram illustrating a thermocompression adhesion unit.

FIG. 5 is a diagram illustrating a stacked state of a sheet bundle.

FIGS. 6A to 6D are diagrams illustrating transfer and cleaning of dirty toners.

FIG. 7 is a diagram illustrating a control unit of the image forming system.

FIG. 8 is a flowchart illustrating a booklet making method in a first embodiment.

FIG. 9 is a diagram illustrating an image forming system.

FIG. 10 is a diagram illustrating a relationship between a heating temperature and a storage elastic modulus of toner.

FIG. 11 is a diagram illustrating a stacked state of a sheet bundle in a second embodiment.

FIGS. 12A and 12B are diagrams illustrating a cleaning method of dirty toners.

FIG. 13 is a flowchart illustrating a booklet making method in a second embodiment.

FIG. 14 is a diagram illustrating a cleaning paper.

FIG. 15 is a flowchart illustrating a cleaning control in a third embodiment.

FIG. 16 is a diagram illustrating an image forming system.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### 1. Image Forming System

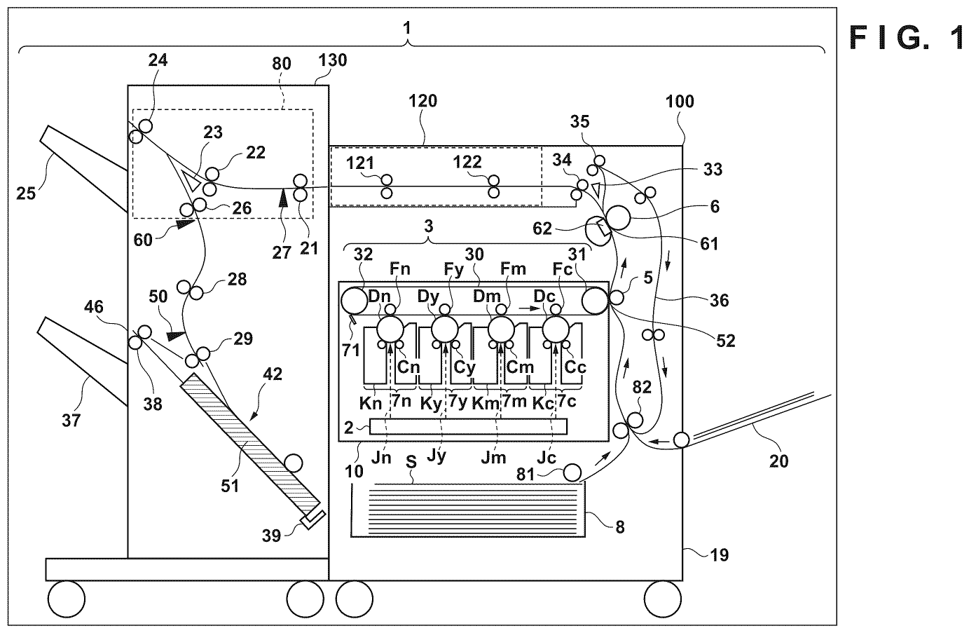

As illustrated in FIG. 1, an image forming system 1 includes an image forming apparatus 100 and a post-processing apparatus 130. The post-processing apparatus 130 is a sheet processing apparatus connected to the image forming apparatus 100. The image forming apparatus 100 forms an image on a sheet S, which is a recording material. An intermediate conveyance unit 120 conveys the sheet S on which the image is formed to the post-processing apparatus 130. The post-processing apparatus 130 performs any post-processing on the sheet S and outputs the sheet S. It should be noted that the image forming system 1 may be understood as a booklet making apparatus, or the post-processing apparatus 130 may be understood as a booklet making apparatus. The image forming system 1 may be referred to as an image forming apparatus.

The image forming apparatus 100 includes a fixing device 6, a sheet cassette 8, an image forming unit 10, and a housing 19 that houses them. The image forming unit 10 forms a toner image on the sheet S fed from the sheet cassette 8. The fixing device 6 performs a fixing process of fixing the toner image on the sheet S.

The sheet cassette 8 is provided at a lower portion of the image forming apparatus 100. The sheet cassette 8 can be inserted into and be pulled out from the housing 19, and can store a large number of sheets S. In this embodiment, it is assumed that the largest size of a sheet S available for an image formation is A4 size (vertical 297 mm×lateral 210 mm). The long side of an A4-sized sheet S and the conveyance direction of the sheet S are parallel to each other. A feed roller 81 feeds the sheet S from the sheet cassette 8, and delivers the sheet S to a conveyance roller pair 82. A multi-tray 20 can also feed the sheets S one by one.

The image forming unit 10 is a tandem-type electrophotographic unit including four process cartridges 7n, 7y, 7m, and 7c, an exposure device 2, and a transfer unit 3. The characters y, m, and c means yellow, magenta and cyan, respectively. The character n means powder adhesive. In the following, by way of illustration, the powder adhesive is referred to as an adhesive toner Tn. The characters n, y, m, and c indicating the colors of the toner may be omitted from the reference numerals. The color of the adhesive toner may be transparent or black. When the color of the adhesive toner is transparent, black is realized by appropriately mixing yellow, magenta, and cyan (process black). The type (material) of the toner used as the adhesive toner and the toner for yellow, magenta, and cyan is, for example, a thermoplastic resin. As examples of thermoplastic resins, there are polyester resins, vinyl resins, acrylic resins, and styrene-acrylic resins. The process cartridges 7n, 7y, 7m, and 7c allow a plurality of components responsible for the image forming process to be replaced integrally. That is, a plurality of components are integrated to form the process cartridges 7n, 7y, 7m, and 7c. It should be noted that the arrangement of the process cartridges 7n, 7y, 7m, and 7c in a rotational direction of a transfer belt 30 is only an example. The process cartridge 7n may be located closer to a secondary transfer roller 5 than the process cartridge 7y, 7m, and 7c.

The process cartridges 7n, 7y, 7m, and 7c include corresponding developing devices Kn, Ky, Km, and Kc, photosensitive drums Dn, Dy, Dm, and Dc, and charging rollers Cn, Cy, Cm, and Cc. The constructions of the process cartridges 7n, 7y, 7m, and 7c are substantially common except for the type of toner.

The developing devices Ky, Km, and Kc include containers containing a powder (e.g., toner), and application rollers (application sleeves) for applying the powder to the photosensitive drums Dn, Dy, Dm, and Dc. More specifically, the developing devices Ky, Km, and Kc contain yellow, magenta, and cyan toners for forming a visible image on the sheet S. The developing device Kn contains an adhesive toner Tn. The adhesive toner Tn is used for forming a user image (document image) and for thermocompression adhering a plurality of sheets S in the post-processing apparatus 130. It should be noted that images are formed by the adhesive toner Tn on the photosensitive drum Dn by being developed by the adhesive toner Tn.

The image forming unit 10 may include a fifth process cartridge using adhesive-only or black toner. It should be noted that the type and the number of print toners can be changed according to the application of the image forming apparatus 100.

The charging rollers Cn, Cy, Cm, and Cc are chargers that uniformly charge the respective corresponding surfaces of the photosensitive drums Dn, Dy, Dm, and Dc. The exposure device 2 is disposed below the process cartridges 7n, 7y, 7m, and 7c, and above the sheet cassette 8. The exposure device 2 irradiates the photosensitive drums Dn, Dy, Dm, and Dc with the respective corresponding laser beams Jn, Jy, Jm, and Jc to form electrostatic latent images. The exposure device 2 may be referred to as an optical scanning device.

The developing devices Kn, Ky, Km, and Kc form toner images by attaching toner to the electrostatic latent images on photosensitive drums Dn, Dy, Dm, and Dc. The developing devices Kn, Ky, Km, and Kc may be referred to as developing apparatuses.

The transfer unit 3 includes the transfer belt 30 as an intermediate transfer body (secondary image carrier). The transfer belt 30 is an endless belt wound around an inner roller 31 and a tension roller 32. An outer peripheral surface (image forming surface) of the transfer belt 30 faces the photosensitive drums Dn, Dy, Dm, and Dc. Primary transfer rollers Fn, Fy, Fm, and Fc are disposed on the inner periphery of the transfer belt 30 so as to face the photosensitive drums Dn, Dy, Dm, and Dc.

The primary transfer rollers Fn, Fy, Fm, and Fc transfer toner images from the corresponding photosensitive drums Dn, Dy, Dm, and Dc to the transfer belt 30. The primary transfer rollers Fn, Fy, Fm, and Fc may be referred to as a primary transfer device. When the transfer belt 30 rotates counterclockwise, the toner images are conveyed to a secondary transfer portion.

A secondary transfer roller 5 is disposed so as to face the inner roller 31, and forms a transfer nip 52 between the secondary transfer roller 5 and the transfer belt 30. The transfer nip 52 transfers the toner image from the transfer belt 30 to the sheet S. The transfer nip 52 may be referred to as a secondary transfer portion. A cleaning blade 71 is a cleaning member for cleaning the toner remaining on the transfer belt 30. The toner scraped off by the cleaning blade 71 is accumulated in a collection container (not illustrated).

A fixing device 6 is disposed above the secondary transfer roller 5 (downstream-side in the conveyance direction of the sheet S). The fixing device 6 applies heat and pressure to the sheet S passing through a fixing nip 61. Accordingly, the toner image is fixed on the sheet S. It should be noted that the fixing device 6 includes a fixing heater 62 for heating the toner image and the sheet S. The fixing heater 62 is, for example, a halogen heater or a ceramic heater.

As illustrated in FIG. 1, a switching guide 33 is a flap-shaped guide member provided downstream of the fixing device 6 in the conveyance direction of the sheet S. When a single-sided printing mode for forming an image on one side of the sheet S is selected, the switching guide 33 guides the sheet S to the discharge roller 34. When a double-sided printing mode for forming an image on both sides of the sheet S is selected, the switching guide 33 guides the sheet S on which an image has been formed on the first surface to a switchback roller pair 35. The switchback roller pair 35 conveys the sheet S in a first direction. When the trailing edge of the sheet S is ready to enter a double-sided conveyance path 36, the switchback roller pair 35 starts reversing. Accordingly, the sheet S is conveyed to the double-sided conveyance path 36. The double-sided conveyance path 36 conveys the sheet S to the secondary transfer portion again. Accordingly, an image is formed on a second surface of the sheet S.

A discharge roller 34 conveys the sheet S to the intermediate conveyance unit 120. The intermediate conveyance unit 120 includes conveyance roller pairs 121 and 122. The conveyance roller pairs 121 and 122 convey the sheet S to the post-processing apparatus 130.

### 2. Post-Processing Apparatus

The post-processing apparatus 130 is a floor-standing type sheet processing apparatus. The post-processing apparatus 130 includes a mechanism for buffering a plurality of sheets, a mechanism for aligning the plurality of sheets, and a mechanism for bonding (thermocompression adhering) the sheet bundle.

Hereinafter, an end portion of the sheet S on the front side in the conveyance direction is referred to as a leading edge. An end portion of the sheet S on the rear side in the conveyance direction is referred to as a trailing edge. Of the two ends of the sheet S, the end that enters the post-processing apparatus 130 first is referred to as the first end. Of the two ends of the sheet S, the end that enters the post-processing apparatus 130 later is referred to as the second end. It should be noted that in some cases, the leading edge is changed from the first end to the second end, and the trailing edge is changed from the second end to the first end by the switchback conveyance executed by the post-processing apparatus 130.

The sheet S conveyed from the intermediate conveyance unit 120 is transferred to an entrance roller 21 of the post-processing apparatus 130. A sheet sensor 27, referred to an entrance sensor, is disposed downstream of the entrance roller 21. When the sheet sensor 27 detects the trailing edge of the sheet S, a conveyance roller pair 22 accelerates the sheet S. When the trailing edge of the sheet S, which is set as an upper tray 25 at a discharge destination, arrives between the conveyance roller pair 22 and a conveyance roller pair 24, the conveyance roller pair 22 decelerates. Accordingly, the conveyance speed of the sheet S becomes a predetermined discharge speed. The conveyance roller pair 24 discharges the sheet S to the upper tray 25.

When the trailing edge of the sheet S whose discharge destination is set at a lower tray 37 passes through a backflow prevention valve 23, the conveyance roller pair 24 stops the conveyance of the sheet S. Thereafter, the conveyance roller pair 24 starts a reverse rotation. Accordingly, the sheet S is switched back and conveyed to a conveyance roller pair 26. When a sheet sensor 60 provided downstream of the conveyance roller pair 26 detects the leading edge of the sheet S, the two rollers constituting the conveyance roller pair 24 are separated from each other. Accordingly, the conveyance roller pair 24 can receive a subsequent sheet S. Further, the conveyance roller pair 26 is stopped in a state where the conveyance roller pair 26 is nipping the preceding sheet S. The conveyance roller pair 26 starts reversing in accordance with the arrival of the subsequent sheet S. Accordingly, the subsequent sheet S is stacked on the preceding sheet S. When the conveyance roller pair 26 repeats the switchback of the sheet(s) S, the plurality of sheets S are stacked to form a sheet bundle. Such a sheet bundle forming operation may be referred to as a buffer operation. The unit that implements the buffer operation is referred to a buffer unit 80. It should be noted that it is not essential to form a sheet bundle in the buffer unit 80. For example, the buffer unit 80 may switch back the sheet S that has arrived from the image forming apparatus 100 and convey the sheet S to an intermediate stacking unit 42. In this case, a sheet bundle is formed in the intermediate stacking unit 42.

When the sheet bundle is completed in the buffer unit 80, the conveyance roller pair 26 conveys the sheet bundle toward the intermediate stacking unit 42. The sheet bundle passes through a conveyance roller pair 28 and a sheet sensor 50. Further, the sheet bundle is conveyed to the intermediate stacking unit 42 by a kick-out roller 29. A movable vertical alignment plate 39 is disposed at the most downstream portion of the intermediate stacking unit 42 at a standby position. When the sheet bundle abuts against the vertical alignment plate 39, the sheet bundle is aligned.

A plurality of sheet bundles are sequentially stacked on the intermediate stacking unit 42. It should be noted that a sheet bundle conveyed to the intermediate stacking unit 42 at the first place is referred to as the first sheet bundle. It should also be noted that a sheet bundle conveyed to the intermediate stacking unit 42 at an i-th place is referred to as an i-th sheet bundle. A sheet bundle conveyed to the intermediate stacking unit 42 at the last place is referred to as an N-th sheet bundle. Accordingly, a predetermined number of sheets S forming a booklet are stacked on the intermediate stacking unit 42. When the alignment of the predetermined number of sheets S is completed, the thermocompression adhesion unit 51 performs a binding operation (thermocompression adhesion process) to form a booklet. The thermocompression adhesion process may be repeatedly executed every time a sheet bundle arrives at the intermediate stacking unit 42. When the vertical alignment plate 39 moves from the standby position to the discharge position, the booklet is pushed toward discharge rollers 38. When the leading edge of the booklet is nipped by the discharge rollers 38, the vertical alignment plate 39 stops and returns to the standby position again. The discharge rollers 38 discharge the booklet received from the vertical alignment plate 39 from a discharge port 46 to the lower tray 37.

In the above description, the post-processing apparatus 130 uses the buffer unit 80 to form a sheet bundle composed of a plurality of sheets S, and conveys the sheet bundle to the intermediate stacking unit 42. However, one sheet S may be conveyed to the intermediate stacking unit 42.

### 3. Print Region of Adhesive Toner Tn

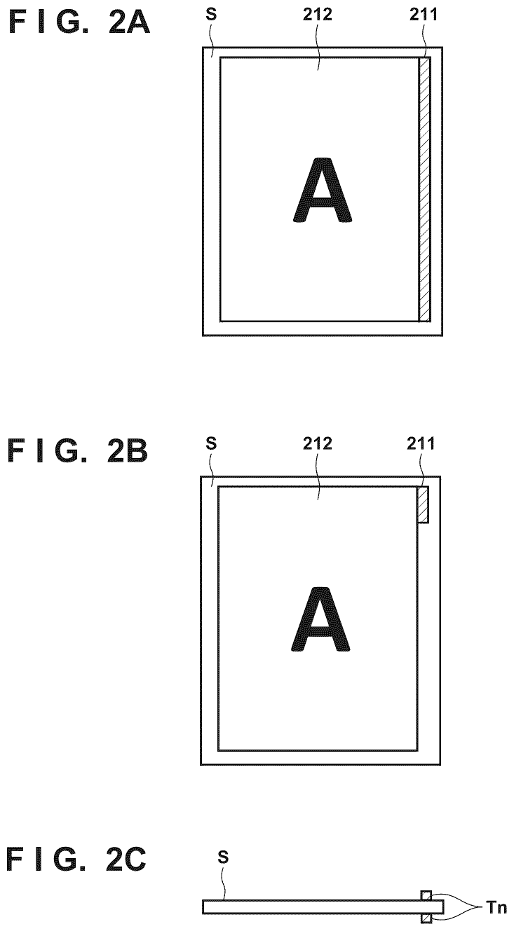

FIG. 2A illustrates a print region 211 of the adhesive toner Tn. The print region 211 is an adhesive region secured for a binding margin of the sheet S. In this example, the print region 211 extends parallel to the long side of the sheet S. The print region 211 is provided at a right end portion or a left end portion close to the long side. In a right-side bound booklet, the print region 211 is arranged at the right end of the sheet S. In a left-side bound booklet, the print region 211 is arranged at the left end of the sheet S. The print region 211 may be provided at upper end portion or a lower end portion close to the short side. The post-processing apparatus 130 stacks the plurality of sheets S and performs heat processing and a pressure processing on the print regions 211 of the plurality of sheets S, whereby the plurality of sheets S are adhered to each other to form a booklet. The booklet in this case is a long-side bound booklet. Here, the width (length in the short side direction) of the adhesive toner image (print region 211) is, for example, 4.0 mm. For example, the amount of toner (applied amount) per unit area of the adhesive toner Tn may be 0.4 mg/cm². The print region 212 is an area in which a user image is printed.

As illustrated in FIG. 2B, a small print region 213 for the adhesive toner Tn may be formed near the corner of the sheet S. Accordingly, a booklet with a corner-bound is made. An image by the adhesive toner Tn is not formed on the sheet S serving as the cover of the booklet. In a right-side bound booklet, the print region 213 is arranged at the upper right end of the sheet S. In a left-side bound booklet, the print region 213 is arranged at the upper left end of the sheet S.

As illustrated in FIG. 2C, the print regions 211 and 213 of the adhesive toner Tn may be formed on both sides of the sheet S, or may be formed only on one side of the sheet S. Whether the print region 211 or 213 of the adhesive toner Tn is formed on only one side or on both sides can be selected in view of, for example, the adhesive capability of the post-processing apparatus 130, the adhesive capability of the adhesive toner Tn, the type of the sheet S, the application required for the booklet, and the like. Booklets that are treated as versions to be preserved require reliable adhesion. Even when a thick paper or a special sheet S is used as the cover of the booklet, a reliable adhesion is required. Therefore, in these cases, the print region 211 of the adhesive toner Tn is provided on both sides of the sheet S. When a simple booklet for primary use is made, the print region 211 of the adhesive toner Tn may be formed on only one side of the sheet S.

When the adhesive toner Tn is applied to both sides of the sheet S, the adhesive toner Tn formed on the front surface of one sheet S and the adhesive toner Tn formed on the back surface of the other sheet are mutually contacted and adhered to each other. It should be noted that the adhesive toner Tn is applied to the back surface of the front cover and the front surface of the back cover, but the adhesive toner Tn is not applied to the front surface of the front cover and the back surface of the back cover.

### 4. Booklet Making Operation

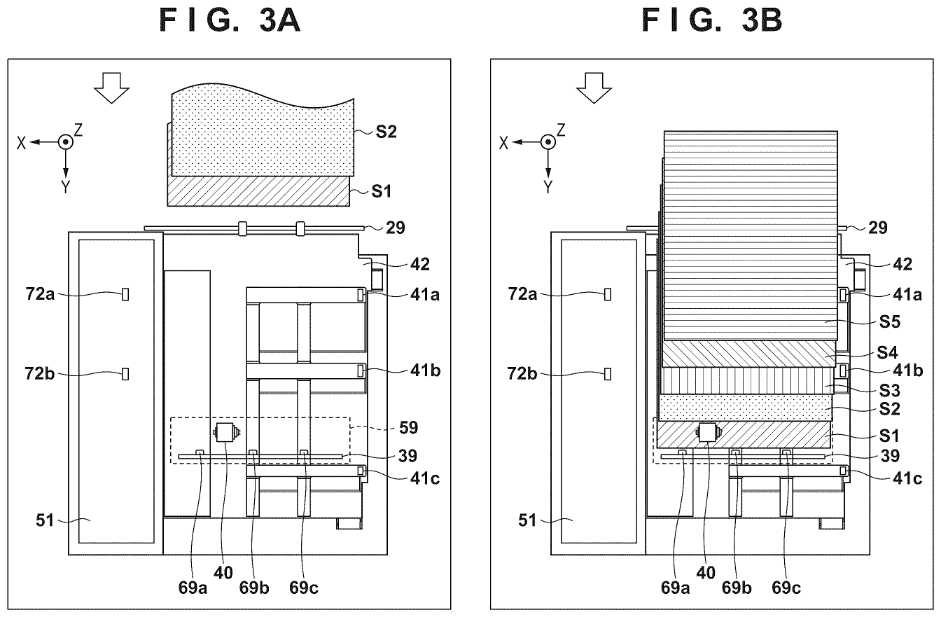

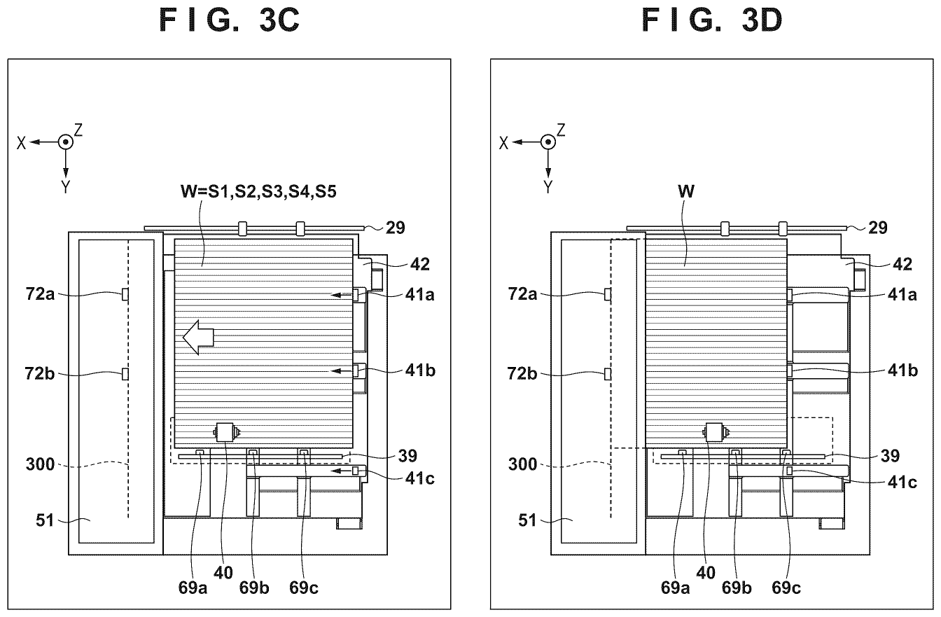

FIGS. 3A to 3D illustrate booklet making operations performed by the intermediate stacking unit 42. In an initial state, the intermediate stacking unit 42 is empty. As an example, a sheet bundle W composed of five sheets S is conveyed from the buffer unit 80 to the intermediate stacking unit 42. The intermediate stacking unit 42 first functions as a support member or a holding member that supports the five sheets S.

The Y direction is a direction parallel to the stacking surface (stacking plate) of the sheet S in the intermediate stacking unit 42 and parallel to the conveyance direction of the sheet S conveyed from the kick-out roller 29 to the intermediate stacking unit 42. The Y direction may be referred to as a vertical direction. The X direction is a direction parallel to the stacking surface of the sheet S in the intermediate stacking unit 42 and orthogonal to the Y direction. The X direction may be referred to as a lateral direction. The Z direction is a direction orthogonal to the X direction and the Y direction (a normal direction of the stacking surface, a thickness direction of the stacked sheet S). The Z direction may be referred to as a height direction. The respective opposing directions for the X, Y, and Z directions may be referred to as a-X direction, a-Y direction, and a-Z direction.

The vertical alignment plate 39 and the vertical alignment roller 40 function as a first alignment unit that aligns the plurality of sheets S in the first direction (Y direction). The vertical alignment plate 39 is disposed at the most downstream portion of the intermediate stacking unit 42 in the Y direction. The vertical alignment plate 39 is a reference member (first reference member) serving as a reference for the sheet position in the Y direction. The vertical alignment roller 40 is a conveying member that conveys the sheet S in the Y direction in order to align the sheet S by abutting it against the vertical alignment plate 39. The vertical alignment plate 39 includes a plurality of contact portions 69a to 69c spaced apart in the X direction. The plurality of contact portions 69a to 69c are in contact with the end portions of the sheets S. It should be noted that the vertical alignment plate 39 and the vertical alignment roller 40 are integrally formed as a movable unit 59 that is movable in the Y direction. The movable unit 59 is movable in the Y direction by a drive source such as a motor. That is, the positions of the vertical alignment plate 39 and the vertical alignment roller 40 in the Y direction can be adjusted. The lateral alignment jogger s41a to 41c function as a second alignment unit that aligns the sheets in a second direction (X direction) orthogonal to the first direction.

The lateral alignment joggers 41a to 41c are moved in the X direction by a drive source such as a motor, and press the lateral end of the sheets S stacked on the intermediate stacking unit 42. The lateral alignment plates 72a and 72b are reference members serving as a reference for the position of the sheets S in the X direction. The lateral alignment plates 72a and 72b are disposed to face the lateral alignment joggers 41a and 41b in the X direction.

### 4-1. Preparatory Stage

As illustrated in FIGS. 3A and 3B, the sheets S1 to S5 are conveyed toward the kick-out roller 29. The sheets S1 to S5 may be conveyed to the intermediate stacking unit 42 in a state where the lower-positioned sheet Sj protrudes in the Y direction more than the upper-positioned sheet Sj+1. Here, j is an index of the sheet S. Before the sheets S are stacked on the intermediate stacking unit 42, the vertical alignment plate 39 is moved to the predetermined standby position in advance, in accordance with the size of the sheet S to be aligned. The standby position is set so that the position of the end portion of the sheet S in the −Y direction is equal to a predetermined position, regardless of the size of the sheet S. In other words, the standby position is such that the distance in the Y direction from the nip position of the kick-out roller 29 to the vertical alignment plate 39 is slightly longer than the length in the Y direction of the sheet. The lateral alignment joggers 41a to 41c stand by at a position outwardly away from the sheet S being conveyed in the X direction so as not to hinder the conveyance of the sheet S.

### 4-2. Vertical Alignment Stage

FIG. 3B illustrates that the trailing edge of the first sheet S1 passes through the nip of the kick-out roller 29, and the leading edge of the sheet S1 arrives at a vertical alignment roller 40. The sheet S1 abuts against the vertical alignment plate 39 and is aligned with respect to the position of the vertical alignment plate 39. As the vertical alignment roller 40 continuously rotates, the sheets S2 to S5 reaching the vertical alignment roller 40 following the sheet S1 are sequentially brought into contact with the vertical alignment plate 39. Accordingly, the five sheets S1 to S5 are aligned in the Y direction (vertical direction) with respect to the position of the vertical alignment plate 39.

### 4-3. Lateral Alignment Stage

FIG. 3C illustrates that the alignment in the X direction (lateral direction) is started after the alignment in the Y direction (vertical direction) of the sheets S1 to S5 is completed. The lateral alignment joggers 41a to 41c are driven in the X direction, which is the alignment direction, and brings into contact with the side ends of the sheets S1 to S5, and presses the sheets S1 to S5 toward the lateral alignment plates 72a and 72b. The other ends of the sheets S1 to S5 bring into contact with a contact surface 300 of the lateral alignment plates 72a and 72b, so that the sheets S1 to S5 are aligned in the X direction (lateral direction) with respect to the positions of the lateral alignment plates 72a and 72b.

### 4-4. Adhesion Stage (Thermocompression Adhesion Stage)

FIG. 3D illustrates a state where the alignment of the five sheets S1 to S5 in the X direction and the Y direction is completed. The target position (alignment position) in the alignment operation is the position of the sheet bundle W when the adhesion process (thermocompression adhesion) is performed by the thermocompression adhesion unit 51. As described above, the image forming apparatus 100 applies the adhesive toner Tn to the sheets S1 to S5 such that the side on which the adhesive toner image is formed is the side of the thermocompression adhesion unit 51. When the sheet S1 is the cover of the booklet, the adhesive toner Tn may not be applied.

The thermocompression adhesion unit 51 applies thermocompression adhesion to the sheets S1 to S5 on which the alignment is completed. During this time, the lateral alignment joggers 41a to 41c are retracted toward the −X direction. Accordingly, the intermediate stacking unit 42 is ready to receive the next plurality of sheets S. Thereafter, the sheet bundle W composed the sheets S6 to S10 generated by the buffer unit 80 is stacked on the sheets S1 to S5.

After that, the four stages described above are repeated for the preceding sheet bundle W composed of the adhered sheets S1 to S5 and the sheet bundle W composed of the un-adhered sheets S6 to S10. Accordingly, the sheets S1 to S10 are adhered with high accuracy and alignment.

As an example, the sheet bundle W is composed of five sheets S. However, the number of sheets S constituting the sheet bundle W may be two or three. That is, the number of sheets S included in the sheet bundle W may be equal to or less than the maximum number of sheets S that can be stacked by the buffer unit 80.

### 5. Thermocompression Adhesion Unit

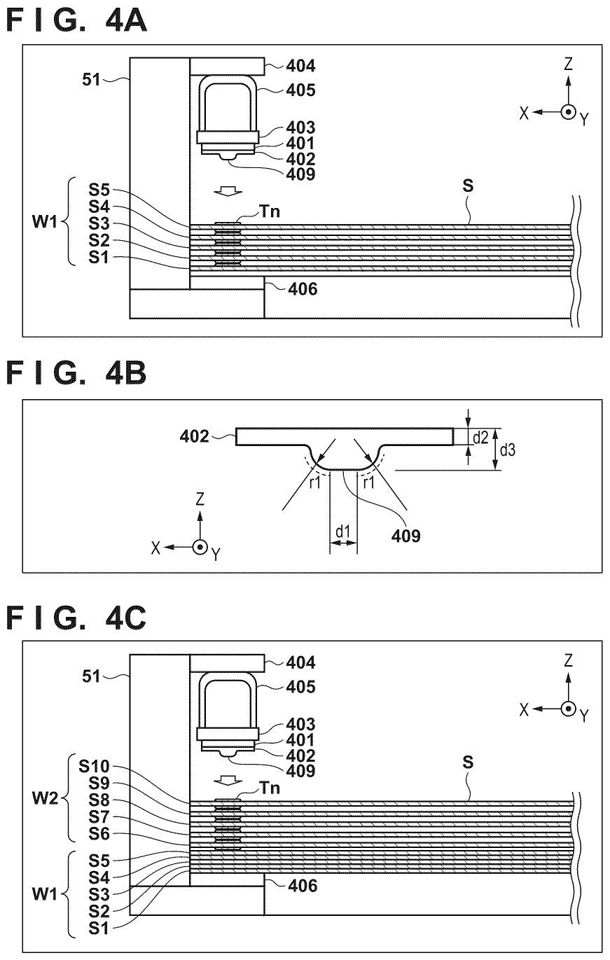

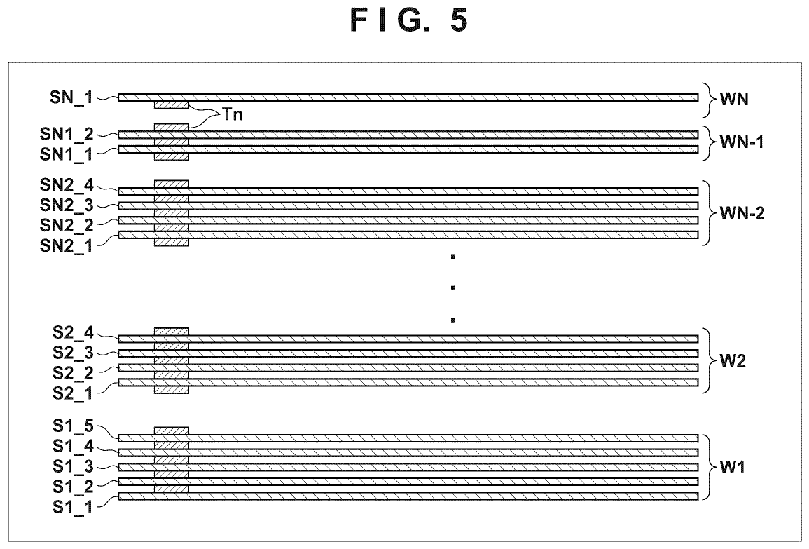

As illustrated in FIG. 4A, the thermocompression adhesion unit 51 includes a heater 401 having a heating element as a heating source, and an aluminum-made heating plate 402 disposed thereon. The surface of the heating plate 402 may be coated. This is to improve the releasability of the toner. The coating composition is, for example, a copolymer of ethylene tetrafluoride and perfluoroalkoxyethylene (PFA). The length (thickness) of the heater 401 in the Z direction is, for example, 1.0 mm. The length (width) of the heater 401 in the X direction is, for example, 8.0 mm. The length of the heater 401 in the Y direction is, for example, 350 mm. The thickness of the heating plate 402 is, for example, 1.5 mm. The heater 401 is, for example, a ceramic heater. The temperature of the heater 401 may be measured by a temperature sensor and controlled by a control circuit so that the measured temperature is equal to the target temperature. For example, the target temperature (e.g., 240° C.) is set so that the surface temperature of the pressurizing portion 409 of the heating plate 402 is equal to 200° C. By providing the pressurizing portion 409 in the heating plate 402, the heat and the pressure of the thermocompression adhesion unit 51 are concentrated at the binding position of the sheet bundle W. As a result, the efficiency of heating and pressure is improved.

FIG. 4B illustrates the dimensions of the heating plate 402. A length d1 represents a length (width) of the pressurizing portion 409 in the X direction. The length d1 is, for example, a 1.0 mm. A thickness d2 represents a thickness of the heating plate 402 is, for example, 0.8 mm. A thickness d3 represents a thickness from the bottom surface of the heating plate 402 to the pressurizing portion 409, and is, for example, 1.5 mm. A curved surface having a curvature r1 is formed on both sides of the pressurizing portion 409. The curvature r1 is, for example, a R1.5 mm. The length of the pressurizing portion 409 in the Y direction is, for example, 300 mm.

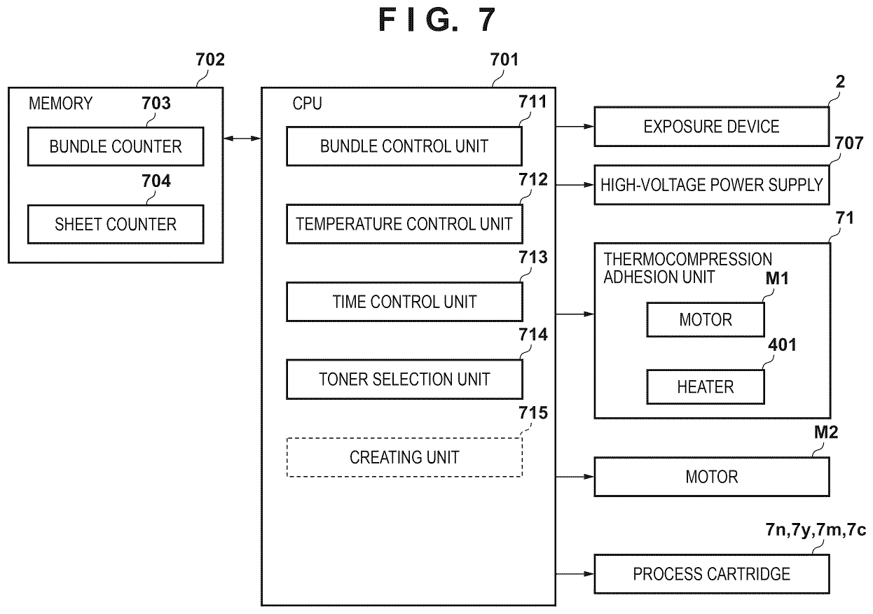

The heater 401 is supported by a resin heater support 403. Since a pressurizing lever 404 presses the thermocompression adhesion unit 51 downward in the −Z direction (downward direction) to pressurize the sheet bundle W, and thus it obtains power from a motor M1 illustrated in FIG. 7. The pressurizing force of the pressurizing lever 404 is transmitted to the pressurizing portion 409 via a metal stay 405 as a rigid body. The pressurizing force of the pressurizing lever 404 can be controlled in accordance with an amount of moving the pressurizing lever 404 in the −Z direction (downward direction). For example, the average surface pressure acting on the sheet bundle W is, for example, 0.2 Mpa. The pressure time (heating time) T1 is, for example, 2.0 seconds.

The pressurizing plate 406 is a reception member formed of an elastic material (e.g., silicone rubber). The elastic material is employed because the pressurizing plate 406 is a member for stably receiving the pressurizing force. The pressurizing plate 406 may also be PFA coated. The thickness of the pressurizing plate 406 is, for example, 2.0 mm. The thermocompression adhesion unit 51 pressurizes the sheet bundle W1 composed of the sheets S1 to S5, and then separates from the sheet bundle W1. In FIG. 4A, the sheets S1 to S5 indicate the first to fifth sheets S1 to S5 of the booklet as a result. The sheet S1 is the cover of the booklet. Therefore, an image of the adhesive toner Tn is not formed on the lower surface of the sheet S1, and an image is formed only on the upper surface. Images of the adhesive toner Tn are formed on the upper and lower surfaces of each sheet in the second and subsequent sheets S2 to S5 of the booklet.

As illustrated in FIG. 4C, the sheet bundle W2 is stacked on the sheets S1 to S5 on which the thermocompression adhesion is completed. The sheet bundle W2 is composed of the sheets S6 to S10. The thermocompression adhesion unit 51 applies the thermocompression adhesion operation to the sheet bundle W2 stacked on the sheet bundle W1. Accordingly, a booklet composed of many sheets S is made. It should be noted that the number of sheets constituting the sheet bundle W1 may be different from the number of sheets constituting the sheet bundle W2.

The sheets S6 to S10 to be stacked later are included in the same booklet as the sheets S1 to S5. Therefore, images of the adhesive toner Tn are formed on the upper surface and the lower surface of the sheets S6 to S10, respectively.

As an example, the post-processing apparatus 130 can make a booklet including up to 100 sheets S. When the making of the booklet is started, the buffer unit 80 buffers up to five sheets S to make a sheet bundle W, and supplies the sheet bundle W to the intermediate stacking unit 42. Each time the sheet bundle W arrives, the thermocompression adhesion unit 51 performs the thermocompression adhesion operation including a lowering operation, a pressurizing operation, and an ascending operation. By repeating the buffering operation and the thermocompression adhesion operation, the booklet is efficiently made without lowering the productivity of the image forming apparatus 100.

When the thermocompression adhesion operation for the sheet bundle W including the final page of the booklet is completed in the intermediate stacking unit 42, the vertical alignment plate 39 moves from the standby position to the discharge position. That is, the vertical alignment plate 39 is translated toward the discharge port 46, whereby the completed booklet is discharged. The discharge rollers 38 are provided at the discharge port 46. When the leading edge of the booklet is nipped by the discharge rollers 38, the vertical alignment plate 39 stops and returns to the standby position again. The discharge rollers 38 discharge the booklet to the lower tray 37.

### 6. Cleaning Control

### 6-1. Controlling the Number of Sheets Forming a Sheet Bundle

In order to shorten the time to make the booklet, there is a need to increase the number of sheets S forming one sheet bundle W. For example, as illustrated in FIG. 4C, the number of sheets S forming the sheet bundle W1 and the number of sheets forming the sheet bundle W2 are respectively set to the maximum value max. The maximum value max is the maximum number of sheets S that can be stacked in the buffer unit 80. When the thermocompression adhesion unit 51 is cleaned, the number of sheets S forming a partial sheet bundle W forming a booklet is changed from the maximum value max.

FIG. 5 illustrates a stacked state of a plurality of sheet bundles W forming a booklet. In the buffer unit 80, a plurality of sheets S are stacked in this order from the lower side to the upper side to form a sheet bundle W.

Here, the total number of sheets S forming the booklet is M sheets. The number of sheet bundles W forming the booklet is N. The maximum number of sheets S forming one sheet bundle W is “max”. Here, the i-th sheet bundle is denoted as Wi. The smaller the value of i is, the faster the sheet bundle Wi arrives at the intermediate stacking unit 42. Further, the larger the value of i is, the closer the sheet bundle Wi in the booklet is to the heating plate 402. The j-th sheet in the sheet bundle Wi is denoted as Si_j. The larger the value of j is, the closer the sheet Si_j in the sheet bundle Wi is to the heating plate 402. The first sheet bundle W1 is formed from max sheets S1_1 to S1_max. Each sheet bundle from the second sheet bundle W2 to N−2th sheet bundle WN−2 is composed of max−1 sheets. An N−1-th sheet bundle WN−1 is formed from x1 sheets S. The sheet bundle WN−1 is the second closest sheet bundle to the heating plate 402 in the booklet. An N-th sheet bundle WN is formed from x2 sheets S. The sheet bundle WN is the closest sheet bundle to the heating plate 402 in the booklet. Here, x1+x2 is equal to or greater than 2 and equal to or less than max. When the sheet bundle WN is composed of one sheet (x2=1), x1 is 1 or more and max−1 or less. In FIG. 5, max is set to 5. Equation (1), below, provides a relationship of these variables.

$$M = max + ( N - 3 ) \times ( max - 1 ) + x 1 + x 2 \qquad ( 1 )$$

The booklet may be a left-bound and long-side bound booklet, and the sheet SN_1 may be a back cover. With the sheet SN_1 as a back cover, no toner images (adhesive layers) of the adhesive toner Tn are provided on the upper surface of the sheet SN_1. A toner image (adhesive layer) formed by the adhesive toner Tn is provided on the lower surface of the sheet SN_1.

With the sheet S1_1 as a front cover, a toner image (adhesive layers) of the adhesive toner Tn is not provided on the lower surface of the sheet S1_1. A toner image (adhesive layer) formed by the adhesive toner Tn is provided on the upper surface of the sheet S1_1.

From the sheet S1_2 to the sheet SN−1_2, toner images (adhesive layers) formed by the adhesive toner Tn are provided on both sides.

In the first embodiment, since max is 5, the number of sheets S forming each sheet bundle from the sheet bundle W2 to the sheet bundle WN−2 is 4. The sum of the number x1 of the sheets S forming the sheet bundle WN−1 and the number x2 of the sheets S forming the sheet bundle WN is any one of two to five sheets depending on the value of M. Therefore, x1 and x2 are adjusted based on Equation (1), above, and the total number M.

As illustrated in FIG. 5, the number x2 of sheets S in the last sheet bundle WN may be set to one. The number x1 of sheets S forming the sheet bundle WN−1 and the number x2 of sheets S forming the sheet bundle WN are less than max. For example, x1 is 2 if the sum of x1 and x2 is 3.

As will be described later, in the first embodiment, the heating temperature of the heater 401 applied to the sheet bundle WN−1 is lower than the heating temperature applied by the other sheet bundles W. If the number of sheets S forming the sheet bundle WN−1 is max or max−1, the heat amount applied to the adhesive toner Tn of the sheet bundle WN−1 is insufficient. Therefore, in the first embodiment, the number x1 of sheets S forming the sheet bundle WN−1 is reduced more than max−1. Accordingly, the heat amount supplied to each adhesive toner Tn of the sheet bundle WN−1 is increased.

In FIG. 5, the number x2 of sheets S forming the sheet bundle WN is 1, but this is only an example. x1 and x2 may each be less than max−1. For example, the number x1 of sheets S forming the sheet bundle WN−1 may be 1. In this case, x2 is 2.

### 6-2. Cleaning Details

As described above, the toner may be transferred from the pressurizing portion 409 to the back cover of the booklet. Therefore, in the first embodiment, the pressurizing portion 409 of the heating plate 402 is cleaned during the pressing process of the sheet bundle WN−1. Accordingly, the back cover is less likely to be contaminated by the toner.

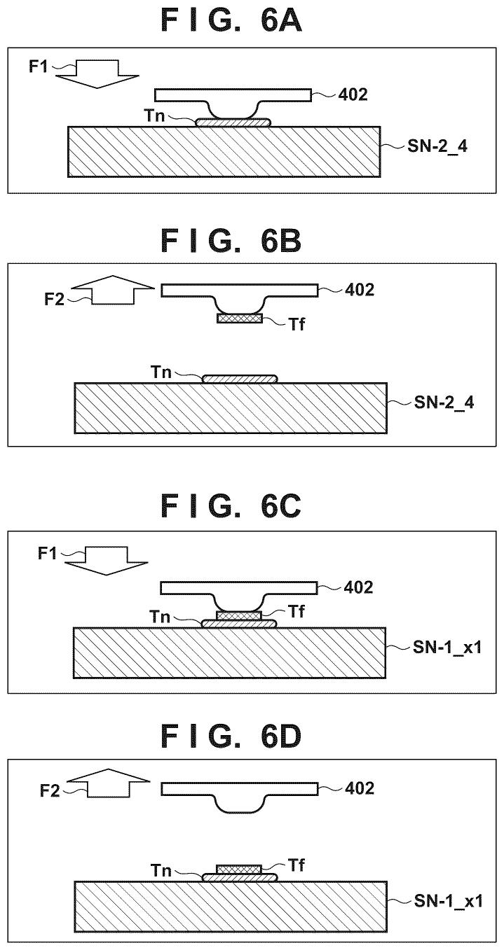

FIG. 6A illustrates a thermocompression adhesion process. At the start of the thermocompression adhesion process, the heating plate 402 is stationary at the standby position. The heating plate 402 moves in a direction (downward direction) indicated by an arrow F1, and brings into contact with toner images formed in the adhesive region of the sheet S by the adhesive toner Tn. Further, the heating plate 402 presses the adhesive toner Tn and the sheet SN−2_4. The heating temperature T1 of the heater 401 is, for example, 200° C. In the last sheet bundle WN, the pressurizing portion 409 of the heating plate 402 directly contacts the sheet SN−2_4 and presses the sheet SN−2_4.

FIG. 6B illustrates a state in which toner is adhered to the heating plate 402. When the predetermined heating period elapses, the heating plate 402 is separated in the direction indicated by the arrow F2 (upward direction). In a normal heating temperature T1, the adhesive toner Tn forming the adhesive layer is sufficiently soft. When the adhesive toner Tn is softened, the adhesive force between the toners in the adhesive layer is less than the adhesive force acting between the adhesive layer and the heating plate 402. Therefore, when the heating plate 402 moves upward, the upper toner separates from the lower toner constituting the adhesive layer, and the upper toner adheres to the heating plate 402 as a dirty toner Tf.

When the heating plate 402 to which the adhesive toner Tn is adhered performs the thermocompression adhesion process on the last sheet bundle WN, the dirty toner Tf adheres to the back cover of the booklet. Therefore, in the first embodiment, a cleaning process is performed to make the dirty toner Tf less likely to adhere to the back cover. This cleaning process is performed prior to the last sheet bundle WN arriving at the thermocompression adhesion unit 51.

FIG. 6C illustrates a cleaning process of the dirty toner Tf adhered to the heating plate 402. The pressurizing portion 409 of the heating plate 402 to which the dirty toner Tf is adhered is in contact with the adhesive layers on the sheet SN−1-x1. Here, the sheet SN−1 x1 is a sheet of interest closest to the heating plate 402 in the sheet bundle WN−1. The temperature of the heating plate 402 is, for example, a heating temperature T2 lower than a normal heating temperature T1. The heating temperature T2 is, for example, 120° C.

The storage elastic modulus of the adhesive toner Tn heated at the heating temperature T2 is greater than the storage elastic modulus of the adhesive toner Tn heated at the heating temperature T1. Therefore, the adhesive force between the adhesive toner Tn forming the adhesive layer is greater than the adhesive force acting between the heating plate 402 and the dirty toner Tf. Further, the adhesive force acting between the adhesive toner Tn of the adhesive layer and the dirty toner Tf is also greater than the adhesive force acting between the heating plate 402 and the dirty toner Tf.

FIG. 6D illustrates a state where the cleaning process of the dirty toner Tf adhered to the heating plate 402 is completed. When the heating plate 402 moves upward, no separation occurs between the adhesive toner Tn forming the adhesive layers. Separation does not occur between the adhesive toner Tn forming the adhesive layer and the dirty toner Tf. On the other hand, separation occurs between the heating plate 402 and the dirty toner Tf. That is, the adhesive toner Tn contained in the adhesive layer pulls the dirty toner Tf adhered to the heating plate 402, thereby separating the dirty toner Tf from the heating plate 402. As a result, the dirty toner Tf is cleaned and removed from the heating plate 402.

### 7. Control Unit

FIG. 7 illustrates a control unit of the image forming system 1. The dashed lines indicate optional functions. A central processing unit (CPU) 701 implements various functions by executing a control program stored in a memory 702. Some or all of these functions may be implemented by hardware circuits such as an application specific integrated circuit (ASIC) or a field-programmable gate array (FPGA). The memory 702 is a storage device that may include a read only memory (ROM), a random access memory (RAM), a hard disk drive (HDD), a solid state drive (SSD), and the like. A bundle counter 703 counts the number or the serial number i of the sheet bundles W held by the intermediate stacking unit 42. A sheet counter 704 counts the number or the serial number j of the sheets S stacked on the buffer unit 80.

A high-voltage power supply 707 generates a charging bias (charging voltage) supplied to the charging roller C and a developing bias (developing voltage) supplied to the developing roller of the developing device K. The CPU 701 adjusts the charging bias or the developing bias to adjust a maximum density of the toner images.

The thermocompression adhesion unit 51 includes the motor M1 for driving the pressurizing lever 404 and the heater 401. The motor M2 drives the feed roller 81 to rotate.

The CPU 701 implements a plurality of functions according to the control program. A bundle control unit 711 controls the number of sheets S included in the sheet bundle W formed in the buffer unit 80. For example, the bundle control unit 711 uses the bundle counter 703 to specify the number i of the sheet bundle W existing in the buffer unit 80. Further, the bundle control unit 711 uses the sheet counter 704 to specify the number j of the sheet S existing in the buffer unit 80. Further, the bundle control unit 711 controls the number of sheets S forming the sheet bundle W1 to be max. The bundle control unit 711 controls the number of sheets S forming each of the sheet bundle W2 to WN−2 to be max−1. The bundle control unit 711 controls the number of sheets S forming the sheet bundle WN−1 to be x1. The bundle control unit 711 controls the number of sheets S forming the sheet bundle WN to be x2. The bundle control unit 711 determines x1 and x2 by using Equation (1), above.

The temperature control unit 712 sets the heating temperature applied to the sheet bundles W1 to WN−2 to T1. The temperature control unit 712 sets the heating temperature applied to the sheet bundle WN−1 to T2. The temperature control unit 712 sets the heating temperature applied to the sheet bundle WN to T3. Here, the heating temperature T2 is lower than the heating temperature T1. The heating temperature T3 is equal to the heating temperature T1 or exceeds the heating temperature T1.

A time control unit 713 controls the time during which the heating plate 402 is performing the thermocompression adhesion (pressurizing and heating) to the sheet bundle W. For any of the sheet bundles W1 to WN, the heating time is, for example, 2.0 seconds.

A toner selection unit 714 selects the type of toner used to form a toner image in the adhesive region of the sheet S. In the first embodiment, a transparent toner may be selected as the adhesive toner Tn, or a black toner may be selected.

A creating unit 715 is an option and is used in the third embodiment. The creating unit 715 controls the image forming apparatus 100 to create a cleaning paper. The cleaning paper may be referred to as a cleaning sheet.

### 8. Flowchart

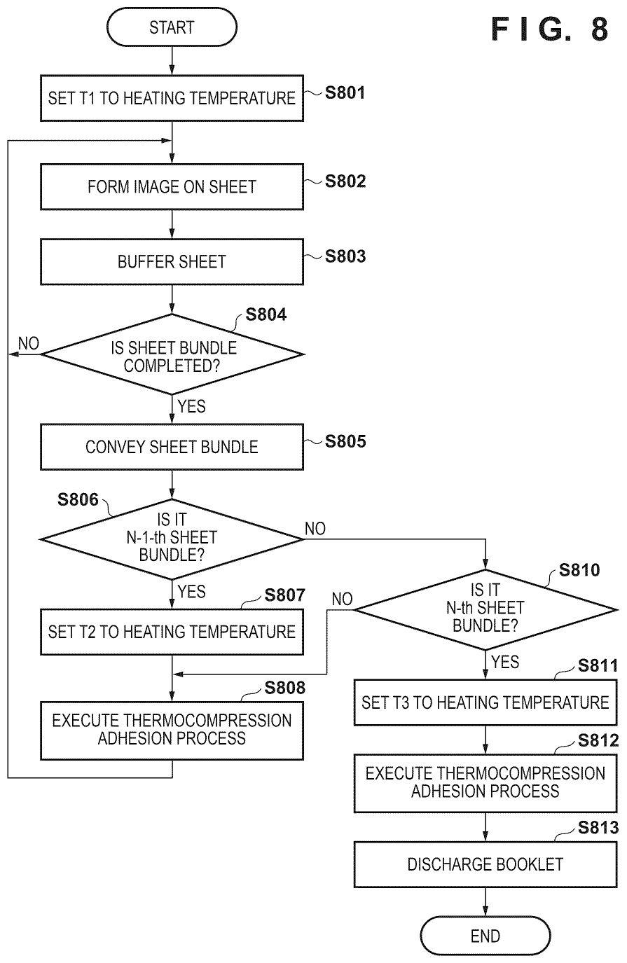

FIG. 8 illustrates a booklet making method including a cleaning process. When a booklet making job is entered, the CPU 701 executes the following process according to the control program. It should be noted that in FIG. 8, for convenience of explanation, the image forming process, the bundle making process, and the thermocompression adhesion process are sequentially executed, but these processes may be executed in parallel.

In step S801, the CPU 701 (temperature control unit 712) sets the heating temperature of the heater 401 to T1. The heating temperature T1 is, for example, 200° C. The heating temperature T1 may be changed according to a basis weight of the sheet S. T2 and T3 are also adjusted according to the basis weight. However, even if the heating temperature T1 is changed, T1 is greater than T2, and T3 is equal to or greater than T1.

In step S802, the CPU 701 (bundle control unit 711) controls the image forming apparatus 100 to form a user image and an adhesive image on the sheet S using the toner. Adhesive images are formed on both sides of each sheet except for the front cover and the back cover. The bundle control unit 711 manages the j-th sheet Si_j in the i-th sheet bundle Wi by using the bundle counter 703 and the sheet counter 704.

In step S803, the CPU 701 (bundle control unit 711) controls the image forming apparatus 100 and the post-processing apparatus 130 to convey the sheet S to the buffer unit 80. The buffer unit 80 makes a sheet bundle W.

In step S804, the CPU 701 (bundle control unit 711) determines whether or not the i-th sheet bundle Wi is completed. For example, when the first sheet W1 is being made in the buffer unit 80, it is determined that the sheet bundle W1 has been completed if the sheet S that has arrived at the buffer unit 80 is the max-th sheet. When the N−2-th sheet bundle WN−2 is being made in the buffer unit 80, it is determined that the sheet bundle WN−2 has been completed if the sheet S that has arrived at the buffer unit 80 is the max-1-th sheet. When the N−1-th sheet bundle WN−1 is being made in the buffer unit 80, it is determined that the sheet bundle WN−1 has been completed if the sheet S that has arrived at the buffer unit 80 is the x1-th sheet. When the N-th sheet bundle WN is being made in the buffer unit 80, it is determined that the sheet bundle WN has been completed if the sheet S that has arrived at the buffer unit 80 is x2-th sheet. When the sheet bundle W is not completed, the CPU 701 processes from step S804 to step S802 to form images on the subsequent sheet S. On the other hand, when the sheet bundle W is completed, the CPU 701 advances the process from step S804 to step S805.

In step S805, the CPU 701 (bundle control unit 711) conveys the sheet bundle W from the buffer unit 80 to the intermediate stacking unit 42. When the preceding sheet bundle Wi−1 has been stacked on the intermediate stacking unit 42, the sheet bundle Wi is stacked on the sheet bundle Wi−1.

In step S806, the CPU 701 (temperature control unit 712) determines whether or not the sheet bundle Wi that has arrived at the intermediate stacking unit 42 is the N−1-th sheet bundle WN−1. When the sheet bundle Wi that has arrived at the intermediate stacking unit 42 is the N−1-th sheet bundle WN−1, the CPU 701 proceeds the process from step S806 to step S807.

In step S807, the CPU 701 (temperature control unit 712) sets the heating temperature of the heater 401 to T2. The heating temperature T2 is lower than the heating temperature T1, for example 120° C.

In step S808, the CPU 701 (temperature control unit 712) controls the thermocompression adhesion unit 51 to execute the thermocompression adhesion process. The thermocompression adhesion time is, for example, 2 seconds. After that, the CPU 701 proceeds from step S807 to step S802.

When it is determined in step S806 that the sheet bundle Wi that has arrived at the intermediate stacking unit 42 is not the N−1-th sheet bundle WN−1, the CPU 701 proceeds from step S806 to step S810.

In step S810, the CPU 701 (temperature control unit 712) determines whether or not the sheet bundle Wi that has arrived at the intermediate stacking unit 42 is the N-th sheet bundle WN. When the sheet bundle Wi that has arrived at the intermediate stacking unit 42 is any of the first to the N−2-th sheet bundles, the CPU 701 proceeds the process from step S810 to step S808. Therefore, the heating temperature is maintained at T1. The thermocompression adhesion time is, for example, 2 seconds. On the other hand, when the sheet bundle Wi that has arrived at the intermediate stacking unit 42 is the N-th sheet bundle WN, the CPU 701 proceeds the process from step S810 to step S811.

In step S811, the CPU 701 (temperature control unit 712) sets the heating temperature of the heater 401 to T3. The heating temperature T3 is equal to the heating temperature T1 or exceeds heating temperature T1.

In step S812, the CPU 701 (temperature control unit 712) controls the thermocompression adhesion unit 51 to execute the thermocompression adhesion process. The thermocompression adhesion time is, for example, 2 seconds.

In step S813, the CPU 701 (temperature control unit 712) controls the thermocompression adhesion unit 51 and the discharge rollers 38 to discharge the completed booklet to the lower tray 37.

In this way, the heating temperature applied to the sheet bundle WN−1 is lower than the normal temperature. Therefore, in the sheet bundle WN−1, the adhesive toner Tn of the sheet SN−1_x1 closest to the pressurizing portion 409 becomes relatively hard. That is, the storage elastic modulus is relatively increased. Accordingly, when the heating plate 402 is separated from the sheet bundle WN−1, the adhesive toner Tn is less likely to be separated from the sheet bundle WN−1. Further, the adhesive toner Tn adhered to the sheet bundle WN−1 pulls the dirty toner Tf adhered to the heating plate 402. Therefore, the dirty toner Tf is separated from the heating plate 402. That is, the dirty toner adhered to the pressurizing portion 409 of the heating plate 402 is removed or cleaned.

When conducting experiments, it was found that when the heating temperature T2 was made equal to the heating temperature T1, dirty toner Tf sometimes adhered to the back cover of the booklet. On the other hand, when the heating temperature T2 was lower than the heating temperature T1, the dirty toner Tf hardly adhered to the back cover of the booklet.

According to FIG. 5, M sheets S are stacked such that the sheet S1_1 is a front cover and the sheet SN_1 is a back cover. However, this stacking order is only an example. A plurality of sheets S may be stacked such that the sheet S1_1 serves as a back cover and the sheet SN_1 serves as a front cover. In this case, adhesion of the dirty toner Tf to the front cover of the booklet is suppressed. Adhesion of unintended toner to the cover of the booklet is reduced.

In the first embodiment, since the heating temperature of the sheet bundle WN−1 is set to T2, the heat amount for adhering the sheet bundle WN−1 and the sheet bundle WN may be insufficient. However, by setting the heating temperature T3 of the sheet bundle WN to be equal to or greater than T1, the insufficient of heat amount is reduced. That is, the adhesive force between the sheet bundle WN−1 and the sheet bundle WN is sufficiently secured.

The number x1 of sheets S forming the sheet bundle WN−1 and the number x2 of sheets S forming the sheet bundle WN are both less than max−1. This also helps to reduce the insufficient of the heat amount.

Although FIG. 1 illustrates the image forming apparatus 100 capable of forming color images, this is only an example. The image forming apparatus 100 may be a monochrome image forming apparatus.

According to the first embodiment, the intermediate stacking unit 42 functions as a holding plate that holds the sheet bundle W composed of one or a plurality of sheets on which toner images by the adhesive toner Tn are formed in the adhesive regions. The pressurizing plate 406 and the pressurizing portion 409 function as a pressurizing plate that applies pressure to the sheet bundle W held by the intermediate stacking unit 42. The heater 401 and the heating plate 402 function as a heater that applies heat to the adhesive toner Tn adhered to the adhesive regions of the respective sheets S included in the sheet bundle W held by the intermediate stacking unit 42. The discharge rollers 38 function as a discharge unit that discharges the booklet when the booklet including the N sheet bundles W is completed. The heater 401 and the heating plate 402 may perform the heat processing every time the sheet bundle W is stacked on the intermediate stacking unit 42. In the booklet, the sheet bundle W second closest to the heating plate 402 is the N−1-th sheet bundle WN−1. Further, the sheet of interest closest to the heating plate 402 in the sheet bundle WN−1 is the sheet SN−1_x1. Any sheet S included in another sheet bundle W located farther from the heating plate 402 than the sheet bundle WN−1 in the booklet may be referred to as another sheet. The other sheets may be sheets closest to the heating plate 402 in the sheet bundle W1 to the sheet bundle WN−2 in the booklet, respectively. The storage elastic modulus of the toner image by the adhesive toner formed on the sheet of interest is greater than the storage elastic modulus of the toner image by the adhesive toner formed on the other sheet. Accordingly, adhesion of unintended toner to the cover of the booklet is reduced.

The heater 401 and the heating plate 402 perform heat processing on the sheet bundles W1 to WN−2 at a first temperature (e.g., T1). The heater 401 and the heating plate 402 may perform heat processing on the sheet bundle WN−1 at a second temperature (e.g., T2) lower than the first temperature. Accordingly, the storage elastic modulus of the toner image by the adhesive toner formed on the sheet of interest is greater than the storage elastic modulus of the toner image by the adhesive toner formed on the other sheet.

When the sheet bundle WN is stacked in the sheet bundle WN−1 in the intermediate stacking unit 42, the heater 401 and the heating plate 402 may perform heat processing at a third temperature (e.g., T3) equal to or exceeding the first temperature. Accordingly, a problem (insufficient of the heat amount) that can be caused by applying the second temperature to the sheet bundle WN−1 is solved.

The number x2 of sheets S forming the sheet bundle WN may be less than the number x1 of sheets S forming the sheet bundle WN−1. Accordingly, the heat amount may be replenished to the sheet bundle WN−1.

At least one of the number x2 of sheets S forming the sheet bundle WN and the number x1 of sheets S forming the sheet bundle WN−1 may be 1. When x2 is 1, heat may easily propagate from the heating plate 402 to the sheet bundle WN−1 via the sheet bundle WN. When x1 is 1, the number of sheets S that are insufficient in the heat amount is minimized. Therefore, the heat amount is easily replenished to the sheet bundle WN−1 via the sheet bundle WN.

At least one of the number x2 of sheets S forming the sheet bundle WN and the number x1 of sheets S forming the sheet bundle WN−1 may be less than the number (e.g., max−1) of sheets S forming the sheet bundle WN−2. Accordingly, the heat amount is easily replenished to the sheet bundle WN−1 via the sheet bundle WN.

At least one of the number x2 of sheets S forming the sheet bundle WN and the number x1 of sheets S forming the sheet bundle WN−1 may be less than the maximum value (e.g., max) of the number of sheets S forming each sheet bundle in the sheet bundles W1 to WN−2. Accordingly, the heat amount is easily replenished to the sheet bundle WN−1 via the sheet bundle WN.

The heating plate 402 may be disposed to face the pressurizing plate 406. The sheet bundle may be pressurized by sandwiching the sheet bundle held by the intermediate stacking unit 42 between the heating plate 402 and the pressurizing plate 406.

According to FIG. 4A, the heating plate 402 is located above the pressurizing plate 406, but this is only an example. It may be located above the pressurizing plate 406 and below the pressurizing plate 406. Further, the heating plate 402 may be stationary and the pressurizing plate 406 may move. Alternatively, both the heating plate 402 and the pressurizing plate 406 may move. In any case, the distance between the heating plate 402 and the pressurizing plate 406 may be variable by the relative movement between the heating plate 402 and the stationary.

### Second Embodiment

The second embodiment is a method of cleaning the heating plate 402 by forming an adhesive layer using a plurality of toners having different storage elastic modulus. In the second embodiment, description of matters common to the first embodiment will be omitted.

### 1. Image Forming Apparatus

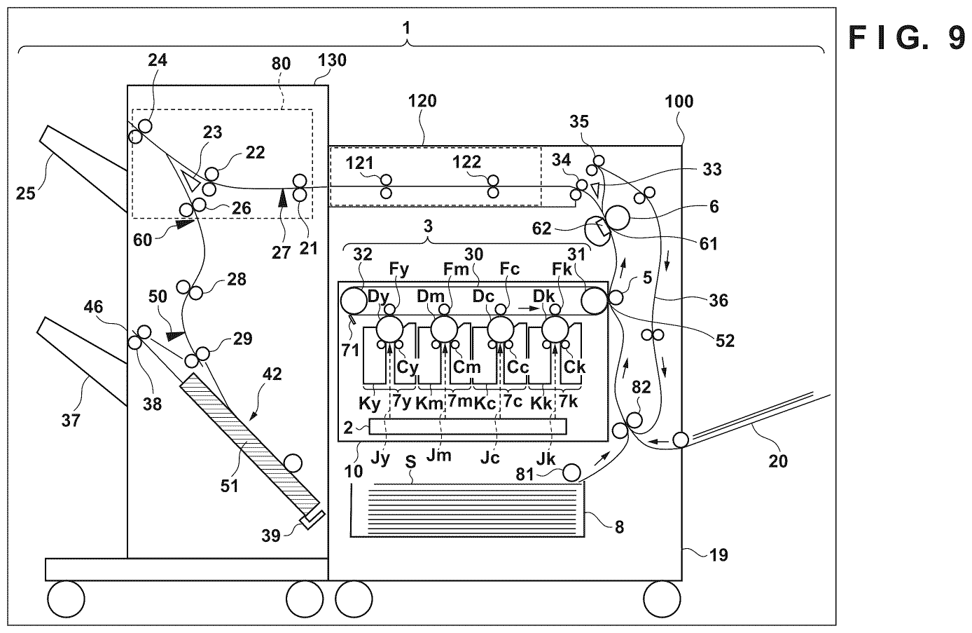

FIG. 9 illustrates an image forming apparatus 100 that can be used in the first embodiment and the second embodiment. The difference between FIG. 9 and FIG. 1 is that a process cartridge 7k for black toner is employed instead of the process cartridge 7n. Further, the black process cartridge 7k is disposed most downstream in the rotational direction of the transfer belt 30. The process cartridge 7k includes a developing device Kk, a photosensitive drum Dk, and a charging roller Ck. The exposure device 2 irradiates the photosensitive drum Dk with the corresponding laser beam Jk to form an electrostatic latent image. A primary transfer roller Fk is arranged to face the photosensitive drum Dk. First, the process cartridge 7y transfers the toner image to the transfer belt 30. Second, the process cartridge 7m transfers the toner image to the transfer belt 30. Third, the process cartridge 7c transfers the toner image to the transfer belt 30. Fourth, the process cartridge 7k transfers the toner image to the transfer belt 30. As a result, a yellow toner image is formed on the top of the sheet S. Second, a magenta toner image is formed. Third, a cyan toner image is formed. Fourth, a black toner image is formed. Therefore, the yellow toner image is formed above the black toner image.

### 2. Method for Measuring Storage Elastic Modulus

The storage elastic modulus of the toner can be measured with a dynamic viscoelasticity measuring device (rheometer). An example of a rheometer is an ARES manufactured by Rheometric Scientific Corporation. A 7.9 mm diameter-serrated parallel plate was used as the measurement tool. A cylindrical sample having an 8 mm diameter and a 2 mm height was molded from the sample of 0.1 g using a pressure molding machine as the sample to be measured. The pressurizing force of 15 kN was applied to the samples at a room temperature for 1 minute. As a pressure molding machine, for example, a 100 kN press NT-100H manufactured by NPa system Corporation was used. The temperature of the serrated parallel plate was set at 120° C. The serrations were bitten into the heated and melted cylindrical sample. Vertically loaded so that axial force did not exceed 30 gf (−0.294 N). Accordingly, the cylindrical sample was fixed to the serrated parallel plate. A steel belt was used so that the diameter of the cylindrical sample was the same as the diameter of the parallel plate. The serrated parallel plate and the cylindrical sample were slowly cooled over 1 hour so that the temperature of the cylindrical sample lowered to the measurement start temperature (=30.00° C.).

A measurement frequency of 31.55 radians/second was employed. The initial value of the measurement distortion was set to 0.1%. Further, measurements were performed in the automatic measurement mode. Extension correction of the samples was performed in an automatic measurement mode. The measured temperature was increased from 30° C. to 180° C. at a rate of 2° C. per minute. The measurement interval is 30 seconds. That is, the viscoelastic data was measured every 1° C.

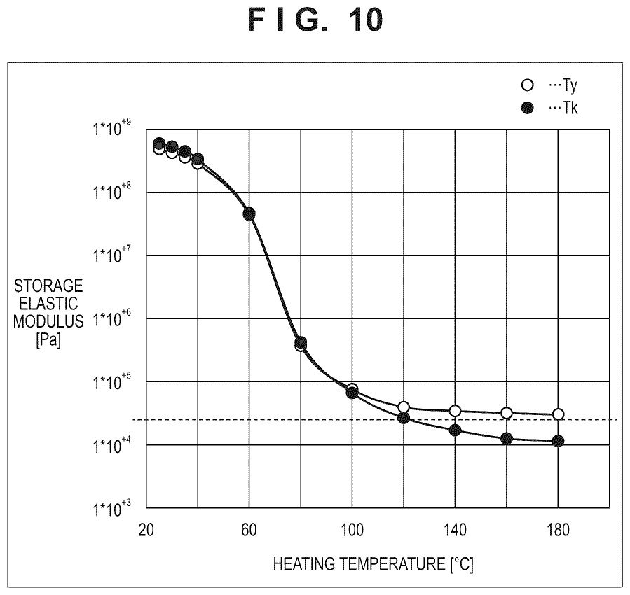

FIG. 10 illustrates an example of measured storage elastic modulus of a black toner Tk and a measured storage elastic modulus of a yellow toner Ty. The lateral axis indicates temperature. The vertical axis illustrates the storage elastic modulus. When these storage elastic modulus are compared, the storage elastic modulus of the black toner Tk is relatively low, particularly in the temperature range of 120° C. or higher. That is, the black toner Tk is a soft toner. The yellow toner Ty has relatively higher storage elastic modulus. That is, the yellow toner Ty is a hard toner.

In the second embodiment, a black toner Tk was employed as an adhesive toner Tn. The yellow toner Ty has been employed as cleaning toner.

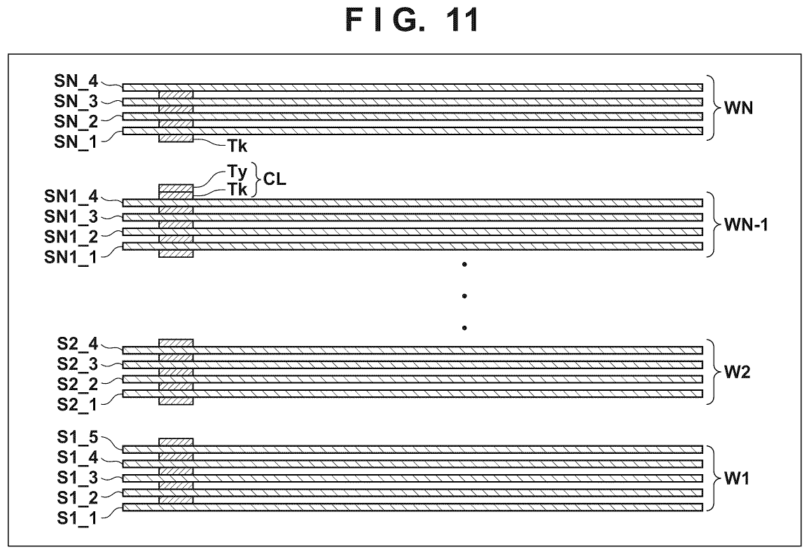

FIG. 11 illustrates a stacked state of a booklet formed from N sheet bundles W. Compared to the first embodiment, the second embodiment differs in that the sheet bundle WN−1 is formed from max−1 sheets S and the sheet bundle WN is also formed from max-1 sheets S.

For the N-th sheet bundle WN from the first sheet bundle W1, an adhesive layer is formed on both sides of the respective sheets S by the black toner Tk as an adhesive toner. However, an adhesive layer is not formed on the lower surface of the sheet S1_1 serving as the front cover and the upper surface of the sheet SN_4 serving as the back cover. Further, in the second embodiment, an adhesive layer of the yellow toner Ty is layered on an adhesive layer of a black toner Tk formed on the upper surface of the sheet SN−1_4. A layer composed of the adhesive layer formed by the black toner Tk and the adhesive layer formed by the yellow toner Ty may be referred to as a cleaning layer CL. In this way, the cleaning layer CL is formed only in the sheet SN−1_4 of the sheet bundle WN−1.

In FIG. 11, the number x2 of sheets S forming the sheet bundle WN is 4, but this is only an example. The number x2 of the sheets S in the sheet bundle WN is determined to be in a range of 1 to 4 sheets in view of the total number M of the sheets S forming the booklet. For example, x2 is determined by the CPU 701 (bundle control unit 711) to satisfy Equation (2), below.

$$M = max + ( N - 2 ) \times ( max - 1 ) + x 2 \qquad ( 2 )$$

Equation (2) is obtained by substituting max−1 into x1 of Equation (1).

### 3. Cleaning

When the black toner Tk is used as the adhesive toner Tn, a dirty toner Tf may adhere to the heating plate 402 as illustrated in FIG. 6B. Therefore, in the second embodiment, the heating plate 402 is cleaned in the sheet bundle WN−1 as in the first embodiment.

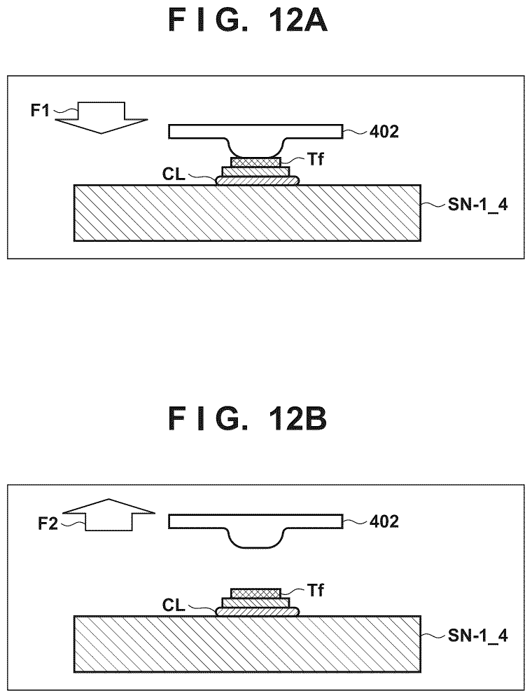

FIG. 12A illustrates a cleaning process of the dirty toner Tf adhered to the heating plate 402. Through the thermocompression adhesion process from the first sheet bundle W1 to the sheet bundle WN−2, the dirty toner Tf is adhered to the pressurizing portion 409 of the heating plate 402. The pressurizing portion 409 may be referred to as a pressurizing surface and a heating surface. When the motor M1 drives the heating plate 402, the heating plate 402 moves in the direction indicated by the arrow F1, and the pressurizing portion 409 brings into contact with the cleaning layer CL. The cleaning layer CL is formed by layering the yellow toner Ty on the black toner Tk. Therefore, the cleaning layer CL is relatively harder than the adhesive layer of the black toner Tk alone. That is, the storage elastic modulus of the cleaning layer CL is relatively greater. Therefore, the adhesive force acting on the toners in the cleaning layer CL is greater than the adhesive force acting between the cleaning layer CL and the heating plate 402. Similarly, the adhesive force acting between the adhesive cleaning layer CL and the dirty toner Tf is greater than the adhesive force acting between the cleaning layer CL and the heating plate 402.

The state illustrated by the FIG. 12B is a state that is temporally later than the state illustrated in the FIG. 12A. When the motor M1 drives the heating plate 402, the heating plate 402 moves in the direction indicated by the arrow F2, and the pressurizing portion 409 separates from the cleaning layer CL. Since the yellow toner Ty is hard, the toners are less likely to be separated in the cleaning layer CL. The dirty toner Tf is not easily separated from the cleaning layer CL. On the other hand, the dirty toner Tf is easily separated from the heating plate 402. In this way, the cleaning layer CL pulls the dirty toner Tf adhered to the heating plate 402, thereby separating the dirty toner Tf from the heating plate 402. As a result, the dirty toner Tf adhered to the heating plate 402 is removed or cleaned.

### 4. Flowchart

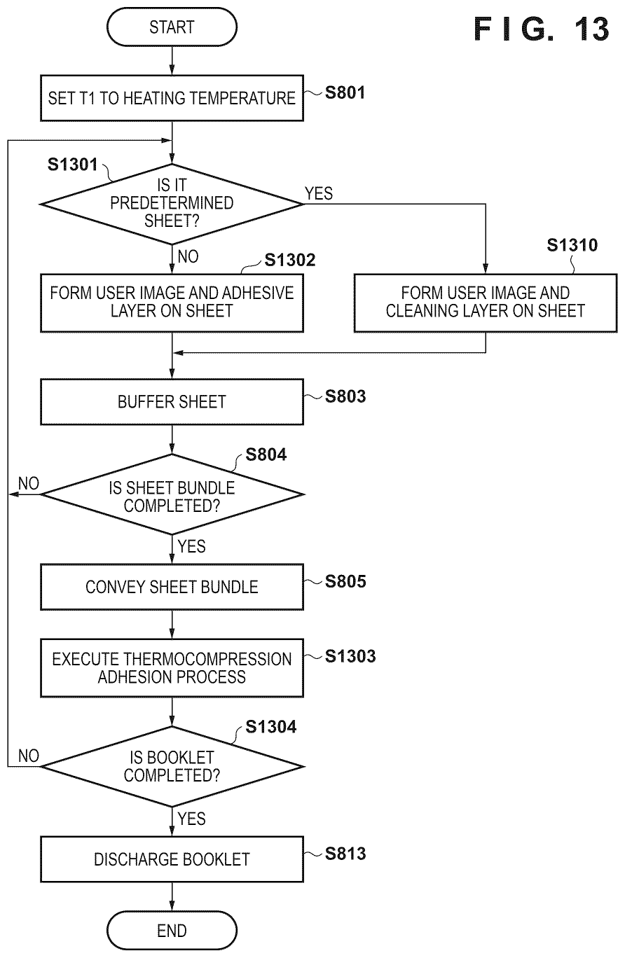

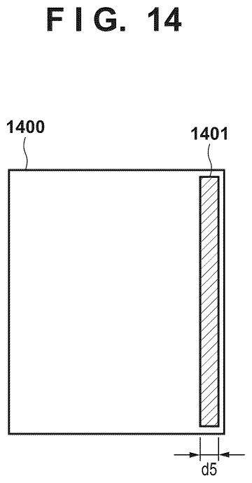

FIG. 13 illustrates a booklet making method according to the second embodiment. Compared to FIG. 8, in FIG. 13, step S802 is replaced with step S1301, step S1302 and step S1310. Further, the process present between step S805 and step S813 is replaced by step S1303 and step S1304. The CPU 701 proceeds from step S801 to step S1301.

In step S1301, the CPU 701 (toner selection unit 714) determines whether the sheet Si_j to be processed is a predetermined sheet SN−1_x1. If the sheet Si_j to be processed is not the predetermined sheet SN−1_x1, the CPU 701 proceeds the process from step S1301 to step S1302.

In step S1302, the CPU 701 (toner selection unit 714) forms a user image and an adhesive layer on the sheet Si_j. The adhesive layer is formed only of the black toner Tk. After that, the CPU 701 proceeds from step S1302 to step S803.

If the sheet Si_j to be processed is the predetermined sheet SN−1_x1, the CPU 701 proceeds the process from step S1301 to step S1310. In step S1310, the CPU 701 (toner selection unit 714) forms a user image and a cleaning layer CL (adhesive image) on the sheet SN−1-x1. The cleaning layer CL is formed by layering the yellow toner Ty on the black toner Tk. After that, the CPU 701 proceeds from step S1310 to step S803. The CPU 701 performs step S803 and step S804 and proceeds to step S805.

When the sheet bundle W is conveyed to the intermediate stacking unit 42 in step S805, the CPU 701 advances the process from step S805 to step S1303. In step S1303, the CPU 701 performs a thermocompression adhesion process on the sheet bundle W. When the sheet bundle W preceding the intermediate stacking unit 42 is present, the thermocompression adhesion process is performed in a state in which the subsequent sheet bundle W is stacked on the preceding sheet bundle W. In the second embodiment, from the first sheet bundle W1 to the last sheet bundle WN, the heating temperature is T1.

The last sheet SN−1_x1 of the sheet bundle WN−1 is provided with the cleaning layer CL. Therefore, in the thermocompression adhesion process of the sheet bundle WN−1, the dirty toner Tf is cleaned.

In step S1304, the CPU 701 determines if the booklet is complete. For example, if the sheet bundle W conveyed to the intermediate stacking unit 42 is the last sheet bundle WN, the CPU 701 determines that the booklet has been completed. If the booklet is not completed, the CPU 701 processes from step S1304 to step S1301. If the booklet has been completed, the CPU 701 proceeds from step S1304 to step S813.

According to the second embodiment, the dirty toner Tf is cleaned in the thermocompression adhesion process of the sheet bundle WN−1 by utilizing the viscoelastic property of the toner. Based on experimentation, the dirty toner Tf hardly adhered to the back cover. Therefore, the effect of the second embodiment was confirmed.

In the flowchart illustrated in FIG. 13, the heating temperature is consistently maintained at T1, but this is only an example. The second embodiment may be combined with the first embodiment. In this case, as described in the first embodiment, the number of sheets S forming the sheet bundle WN−1 is x1, and the number of sheets S forming the sheet bundle WN is x2. The methods for determining x1 and x2 are as described in the first embodiment. Further, in the sheet bundle WN−1, the cleaning layer CL is formed on an x1-st sheet SN−1_x1. The heating temperature for the sheet bundle WN−1 is T2. The heating temperature for the sheet bundle WN is T3. In this way, the cleaning layer CL described in the second embodiment may be added to the control of the number of sheets x1, and x2, and the control of the heating temperature described in the first embodiment.

As the second embodiment suggests, the process cartridge 7k is an example of a first image forming unit that forms a toner image on a sheet with a first toner. The process cartridge 7y is an example of a second image forming unit that forms a toner image on a sheet with a second toner that is harder than the first toner. The first toner (e.g., a black toner Tk) is used as an adhesive toner to form toner images in the adhesive regions of the respective sheets forming the sheet bundle WN−2. In the adhesive region of the sheet of interest forming the sheet bundle WN−1, a toner image is formed using the first toner as the adhesive toner, and another toner image using the second toner (e.g., a yellow toner Ty) is formed on the toner image. The heater 401 and the heating plate 402 may bring into contact with other toner image when the sheet bundle WN−1 is heated. Accordingly, the storage elastic modulus of the toner image by the adhesive toner formed on the sheet of interest is greater than the storage elastic modulus of the toner image by the adhesive toner formed on the other sheet. As a result, adhesion of unintended toner to the cover of the booklet is reduced.

It should be noted that toner images may be formed on the respective adhesive regions of the respective sheets forming the respective sheet bundles from the first sheet bundle W1 to the sheet bundle WN−2 by using the first toner as the adhesive toner. A toner image may be formed on each adhesive region of each sheet forming the N-th sheet bundle WN by using the first toner as the adhesive toner.

In the second embodiment, the heater 401 and the heating plate 402 may perform heat processing on the sheet bundles W1 to WN−2 at a first temperature (e.g., T1). The heater 401 and the heating plate 402 may perform heat processing on the sheet bundle WN−1 at a second temperature (e.g., T2) lower than the first temperature. The heater 401 and the heating plate 402 may perform heat processing on the sheet bundle WN−1 at a third temperature (e.g., T3).

### Third Embodiment

In the first and second embodiments, the cleaning control is executed during the booklet making process. However, this is only an example. In the third embodiment, the cleaning control of the dirty toner Tf is executed during the time when the booklet making process is not executed. The execution timing of the cleaning control may be any timing specified or set by the user. The execution timing may be a timing at which the number of sheets S conveyed to the post-processing apparatus 130 reaches a predetermined number. The execution timing may be a periodic timing. In the third embodiment, the image forming apparatus 100 illustrated in FIG. 1 may be used, or the image forming apparatus 100 illustrated in FIG. 9 may be used.

### 1. Background

If the booklet making is repeated, the toner mixed with paper dust or the like may become a dirty toner Tf and accumulate in the heating plate 402 or the pressurizing plate 406. When such a dirty toner Tf is accumulated in the heating plate 402, the dirty toner Tf may be transferred to the back cover of the booklet. When the dirty toner Tf accumulates on the pressurizing plate 406, the dirty toner Tf may be transferred to the front cover of the booklet. When the dirty toner Tf is transferred to the front cover or the back cover of the booklet, the quality of the booklet lowers. Therefore, in the third embodiment, the cleaning paper cleans the dirty toner Tf from the heating plate 402 and the pressurizing plate 406.

### 2. Cleaning Paper

FIG. 14 illustrates a cleaning paper 1400. The cleaning paper 1400 has a cleaning region 1401 in which toner images for forming the cleaning layer CL are printed. When cleaning both the heating plate 402 and the pressurizing plate 406, the cleaning region 1401 is formed on both the first surface and the second surface of the cleaning paper 1400. The cleaning region 1401 is provided at a right end or a left end of the cleaning paper 1400 so as to be able to bring into contact with a cleaning target (for example, the heating plate 402 and the pressurizing plate 406).

The area of the cleaning region 1401 is larger than the area of the cleaning target so that the cleaning region 1401 covers the entire cleaning target. The width d5 of the cleaning region 1401 is larger than the width of the cleaning target (the width of the heating plate 402 or the width of the pressurizing plate 406). For example, the width d5 is 10 mm.

When only one of the heating plate 402 and the pressurizing plate 406 is to be cleaned, the cleaning paper 1400 printed on one side is used. The arrangement of the cleaning region 1401 is determined in accordance with the arrangement of the cleaning target. That is, in the thermocompression adhesion unit 51, it is sufficient that the cleaning region 1401 can be brought into contact with the cleaning target.

### 3. Flowchart

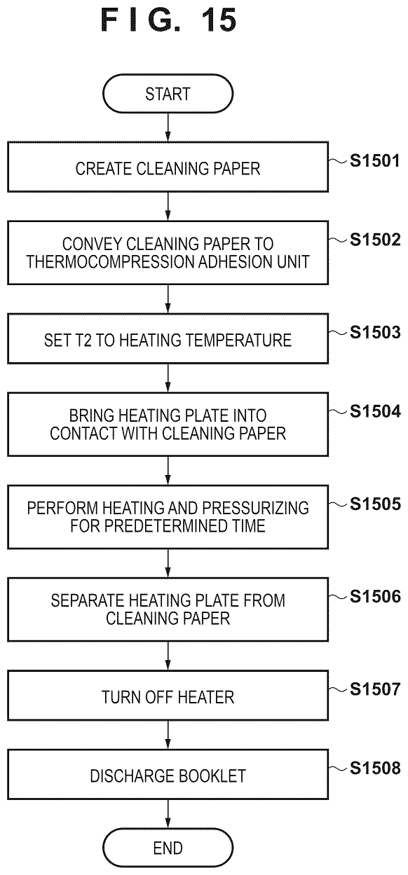

FIG. 15 illustrates a control method using the cleaning paper 1400. When the condition for starting the creation of the cleaning paper 1400 is satisfied, the CPU 701 (creating unit 715) executes the following process according to the control program.

In step S1501, the CPU 701 (creating unit 715) creates the cleaning paper 1400 by controlling the image forming apparatus 100 to form a toner image by the adhesive toner Tn in the cleaning region 1401 of the sheet S. The adhesive toner Tn may be, for example, the black toner Tk alone or both the black toner Tk and the yellow toner Ty.

In step S1502, the CPU 701 controls the image forming apparatus 100 and the post-processing apparatus 130 to convey the cleaning paper 1400 to the thermocompression adhesion unit 51. The cleaning paper 1400 is stacked on the intermediate stacking unit 42 so that the cleaning region 1401 of the cleaning paper 1400 can be brought into contact with the cleaning target (for example, the pressurizing plate 406 and the heating plate 402).

In step S1503, the CPU 701 (temperature control unit 712) sets the heating temperature to T2. As described in the first embodiment, the heating temperature T2 is lower than the normal heating temperature T1. The heating temperature T2 is, for example, 120° C. Accordingly, the storage elastic modulus of the toner image (toner layer) formed in the cleaning region 1401 increases. The temperature control unit 712 supplies power to the heater 401 so that the temperature of the heating plate 402 becomes T2.

In step S1504, the CPU 701 controls the motor M1 to bring the heating plate 402 into contact with the cleaning paper 1400. Accordingly, the dirty toner Tf adhered to the pressurizing plate 406 is in contact with the cleaning region 1401 of the cleaning paper 1400.

In step S1505, the CPU 701 (time control unit 713) executes heating and pressurizing for a predetermined time (e.g., 3 seconds). The predetermined time is longer than the heating time (for example, 2 seconds) when the booklet is made. The dirty toner Tf adhered to the pressurizing plate 406 adheres to the toner images formed in the cleaning region 1401 of the cleaning paper 1400.

In step S1506, the CPU 701 controls the motor M1 to separate the heating plate 402 from the cleaning paper 1400. The dirty toner Tf is transferred to the cleaning paper 1400 and peeled off from the pressurizing plate 406. Accordingly, the dirty toner Tf is removed from the pressurizing plate 406.

In step S1507, the CPU 701 turns off the heater 401. In step S1508, the CPU 701 controls the thermocompression adhesion unit 51 and the discharge rollers 38 to discharge the cleaning paper 1400 to the lower tray 37.

Here, the cleaning method of the dirty toner Tf accumulated in the pressurizing plate 406 is mainly described, but the dirty toner Tf accumulated in the heating plate 402 can also be cleaned. In this case, the cleaning region 1401 is formed in the cleaning paper 1400 so that the cleaning region 1401 can be brought into contact with the heating plate 402. By providing the cleaning region 1401 on both sides of the cleaning paper 1400, the dirty toner Tf accumulated in the heating plate 402 and the dirty toner Tf accumulated in the pressurizing plate 406 can be cleaned simultaneously.

According to the third embodiment, the dirty toner Tf can be removed or reduced without rubbing the cleaning target with the cleaning paper 1400. Therefore, cleaning can be performed in a short time.

In the third embodiment, the cleaning paper 1400 is formed by the image forming apparatus 100 and conveyed to the post-processing apparatus 130, but this is only an example. A cleaning paper 1400 created by another image forming apparatus 100 may be manually placed on the intermediate stacking unit 42.

The material of the cleaning paper 1400 may be paper or a resin film or cloth. Any material that can adsorb the dirty toner Tf can be used.

According to the third embodiment, by cleaning the dirty toner Tf from the cleaning target using the cleaning paper 1400, the cover of the booklet is less likely to be dirty.

The image forming unit 10, the CPU 701, and the creating unit 715 function as a creating unit that creates a cleaning paper 1400 for cleaning the heating plate 402. When the sheet bundle W forming the booklet is not present in the intermediate stacking unit 42 and the cleaning paper 1400 is held by the intermediate stacking unit 42, the heating plate 402 brings into contact with the cleaning paper 1400 to execute the heat processing.

The heating temperature (e.g., T2) applied to the cleaning paper 1400 may be lower than the heating temperature (e.g., T1) applied to the sheet bundle W forming the booklet. This is to increase the storage elastic modulus of the cleaning toner image formed in the cleaning region 1401.

The cleaning paper 1400 may have the cleaning region 1401 corresponding to the cleaning target. That is, the cleaning region 1401 is disposed at a position corresponding to the adhesive region (the print region 211) or the pressurized region. A toner image may be formed in the cleaning region 1401.

The area of the cleaning region 1401 may be larger than the area of the heating surface of the heating plate 402 (the heating and pressurizing surface of the pressurizing portion 409). Accordingly, the dirty toner Tf is easily removed from the pressurizing portion 409.

The cleaning paper 1400 may be in contact with both the heating plate 402 and the pressurizing plate 406. The area of the cleaning region 1401 may be larger than the area of the pressure surface of the pressurizing plate 406. Accordingly, the dirty toner Tf is easily removed from the pressurizing plate 406.

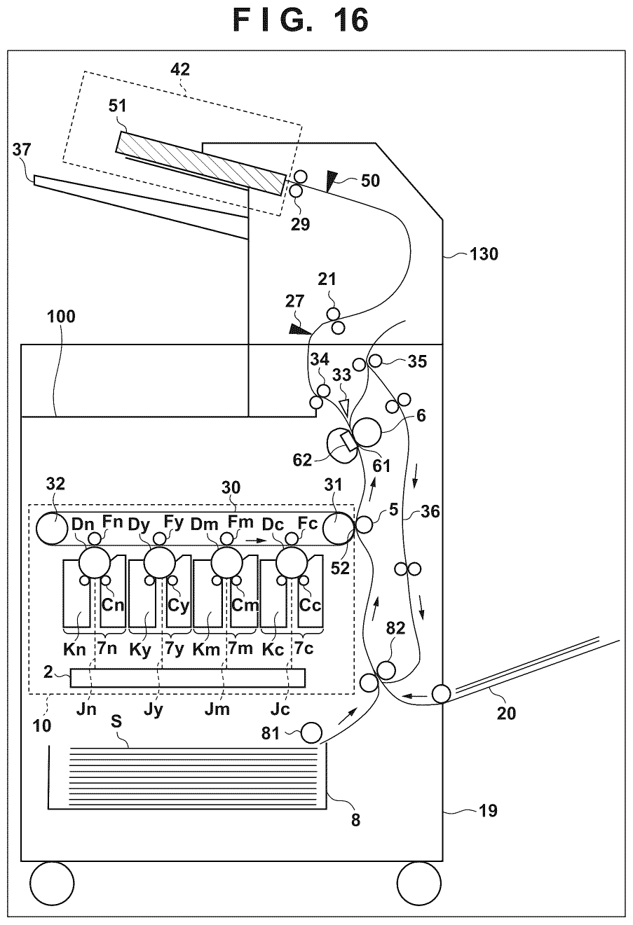

In FIG. 1, the post-processing apparatus 130 with the thermocompression adhesion unit 51 is arranged next to the image forming apparatus 100, but this is only an example. As illustrated in FIG. 16, the post-processing apparatus 130 and the thermocompression adhesion unit 51 may be disposed on the upper portion of the main body of the image forming apparatus 100. As described with reference to FIG. 9, the order of the process cartridges 7n, 7y, 7m, and 7c may be changed. The process cartridge 7k may be employed instead of the process cartridge 7n.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., ASIC) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., CPU, micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a RAM, a ROM, a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims priority to and the benefit of Japanese Patent Application No. 2024-120334, filed Jul. 25, 2024 which is hereby incorporated by reference herein in its entirety.

What is claimed is:

1. A booklet making apparatus comprising:
a holding plate configured to hold a sheet bundle composed of two or more sheets, each of which is formed with a toner image by an adhesive toner in an adhesive region;
a pressurizing plate configured to apply pressure to the sheet bundle held by the holding plate;
a heater configured to apply heat to the toner image formed by the adhesive toner in the adhesive region of each sheet contained in the sheet bundle held by the holding plate; and
a discharging unit configured to discharge a booklet upon completion of the booklet composed of N sheet bundles,
wherein the heater performs heat processing in response to the sheet bundle being stacked on the holding plate, and
a storage elastic modulus of the toner image formed by the adhesive toner on a sheet of interest closest to the heater in an N−1-th sheet bundle second closest to the heater in the booklet is greater than a storage elastic modulus of the toner image formed by the adhesive toner on any sheet included in another sheet bundle located farther from the heater than the N−1-th sheet bundle in the booklet.

2. The booklet making apparatus according to claim 1, wherein a storage elastic modulus of the toner image by the adhesive toner formed on a sheet of interest closest to the heater in a N−1-th sheet bundle second closest to the heater is greater than a storage elastic modulus of the toner image by the adhesive toner formed on another respective sheet closest to the heater in a first sheet bundle to an N−2-th sheet bundle in the booklet.

3. The booklet making apparatus according to claim 1, wherein the heater is configured to perform the heat processing at a first temperature on a first sheet bundle to a N−2th sheet bundle in the booklet, and to perform the heat processing at a second temperature lower than the first temperature on the N−1th sheet bundle.

4. The booklet making apparatus according to claim 3, wherein the heater is configured to perform the heat processing at a third temperature equal to or greater than the first temperature when an N-th sheet bundles is stacked on the N−1-th sheet bundle on the holding plate.

5. The booklet making apparatus according to claim 1, wherein a number of sheets forming an N-th sheet bundle is less than a number of sheets forming the N−1-th sheet bundle in the booklet.

6. The booklet making apparatus according to claim 1, wherein a number of sheets forming an N-th sheet bundle and a number of sheets forming the N−1-th sheet bundle in the booklet is 1.

7. The booklet making apparatus according to claim 1, wherein one or more of a number of sheets forming an N-th sheet bundle and a number of sheets forming the N−1-th sheet bundle in the booklet is less than a number of sheets forming an N−2-th sheet bundle in the booklet.

8. The booklet making apparatus according to claim 1, wherein one or more of a number of sheets forming an N-th sheet bundle and a number of sheets forming the N−1-th sheet bundle in the booklet is less than a maximum number of sheets forming each sheet bundle from a first sheet bundle to an N−2-th sheet bundle in the booklet.

9. The booklet making apparatus according to claim 1, further comprising:
a first image forming unit configured to form a toner image on a sheet with a first toner; and
a second image forming unit configured to form a toner image on the sheet with a second toner harder than the first toner,
wherein the toner image is formed using the first toner as the adhesive toner in each adhesive region of each sheet forming an N−2-th sheet bundle in the booklet, and
wherein the toner image is formed using the first toner as the adhesive toner in the adhesive region of the sheet of interest forming the N−1-th sheet bundle, another toner image using the second toner is formed on the toner image, and the heater is in contact with the other toner image when the N−1-th sheet bundle is heated.

10. The booklet making apparatus according to claim 9, wherein the first toner is used as the adhesive toner to form the toner image in each adhesive region of each sheet forming sheet bundles from a first bundle to N−2-th sheet bundles in the booklet.

11. The booklet making apparatus according to claim 9, wherein the first toner is used as the adhesive toner to form the toner image in each adhesive region of each sheet forming an N-th sheet bundle.

12. The booklet making apparatus according to claim 11, wherein the heater is configured to perform the heat processing at a first temperature to a first sheet bundle to the N−2-th sheet bundle in the booklet, and perform the heat processing at a second temperature lower than the first temperature to the N−1-th sheet bundle.

13. The booklet making apparatus according to claim 1, further comprising a creating unit configured to create a cleaning sheet for cleaning the heater,
wherein the heater is configured such that when a sheet bundle forming the booklet is not present on the holding plate and the cleaning sheet is held by the holding plate, the heater is brought into contact with the cleaning sheet to perform the heat processing.

14. The booklet making apparatus according to claim 1, wherein the heater is arranged to face the pressurizing plate, and
a sheet bundle is pressed by nipping the sheet bundle held by the holding plate by the heater and the pressurizing plate.

15. A booklet making apparatus comprising:
a holding plate configured to hold a sheet bundle composed of one or more sheets each of which is formed with a toner image by an adhesive toner in an adhesive region;
a pressurizing plate configured to apply pressure to the sheet bundle held by the holding plate;
a heater configured to apply heat to the toner image formed by the adhesive toner in the adhesive region of each sheet contained in the sheet bundle held by the holding plate;
a discharging unit configured to discharge a booklet upon completion of the booklet composed of one or more sheet bundles; and
a creating unit configured to create a cleaning sheet for cleaning the heater,
wherein the heater is configured such that when a sheet bundle forming the booklet is not present on the holding plate and the cleaning sheet is held by the holding plate, the heater is brought into contact with the cleaning sheet to perform heat processing.

16. The booklet making apparatus according to claim 15, wherein a temperature applied to the cleaning sheet by the heater is lower than a temperature applied to a sheet bundle forming the booklet by the heater.

17. The booklet making apparatus according to claim 15, wherein the cleaning sheet includes a cleaning region corresponding to the adhesive region, and a toner image is formed in the cleaning region.

18. The booklet making apparatus according to claim 17, wherein an area of the cleaning region is larger than an area of a heating surface of the heater.

19. The booklet making apparatus according to claim 17, wherein the cleaning sheet is in contact with both a heating surface of the heater and the pressurizing plate, and an area of the cleaning region is larger than an area of a pressurizing surface of the pressurizing plate.

20. An image forming system comprising:
an image forming apparatus; and
a post-processing apparatus,
wherein the image forming apparatus includes:
a forming unit configured to form a toner image by an adhesive toner in an adhesive region on a sheet; and
a conveyance unit configured to convey the sheet to the post-processing apparatus,
wherein the post-processing apparatus includes:
a holding plate configured to hold a sheet bundle composed of two or more sheets, each of which is formed with the toner image by the adhesive toner in the adhesive region;
a pressurizing plate configured to apply pressure to the sheet bundle held by the holding plate;
a heater configured to apply heat to the toner image formed by the adhesive toner in the adhesive region of each sheet contained in the sheet bundle held by the holding plate; and
a discharging unit configured to discharge a booklet upon completion of the booklet composed of N sheet bundles,
wherein the heater performs heat processing in response to the sheet bundle being stacked on the holding plate, and
a storage elastic modulus of the toner image formed by the adhesive toner on a sheet of interest closest to the heater in an N−1-th sheet bundle second closest to the heater in the booklet is greater than a storage elastic modulus of the toner image formed by the adhesive toner on any sheet included in another sheet bundle located farther from the heater than the N−1-th sheet bundle in the booklet.
